(19) United States
(12) Patent Application Publication
(10) Pub. No.: US 2010/0094744 A1
(43) Pub. Date: Apr. 15, 2010

(54) CONTRACTS EXCHANGE SYSTEM

(75) Inventors: Oakley E. Van Slyke, San Clemente, CA (US); Brian L. Whitworth, Woodland Hills, CA (US)

Correspondence Address: Myers Andras Sherman LLP, 19900 MacArthur Blvd., Suite 1150, Irvine, CA, 92612, US

(73) Assignee: LIC Development LLC, San Clemente, CA (US)

(21) Appl. No.: 12/414,156

(22) Filed: Mar. 30, 2009

Related U.S. Application Data
(60) Provisional application No. 61/072,588, filed on Mar. 31, 2008.
(60) Provisional application No. 61/072,589, filed on Mar. 31, 2008.
(60) Provisional application No. 61/072,625, filed on Mar. 31, 2008.

(51) Int. Cl. G06Q 40/00; G06Q 50/00

(52) U.S. Cl. 705/37

(57) ABSTRACT

A contracts exchange system includes a liquid contracts exchange, traders trading on the exchange, a securities exchange listing shares of the trader, thereby enabling access to the capital markets, and a surety guaranteeing obligations of the trader. Methods are provided for transferring risk to the capital markets, for operating a liquid contracts exchange, for paying obligations under an exchange traded contract, for calculating sureties, for auditing traders, detecting errors, mistakes or fraud in a trader's financial statements, for assuring compliance by a trader, for estimating a franchise value of a trader, for making a contract tradable on an exchange, and for managing traders in the contract exchange system.

### CROSS REFERENCE TO RELATED APPLICATIONS

This application relates to and claims priority from the following U.S. Provisional Application Serial Nos., the disclosures of which are incorporated herein by reference as if fully set forth:
1) 61/072,588 filed on Mar. 31, 2009 entitled “METHODS OF OPERATING A CONTRACTS EXCHANGE”;
2) 61/072,589 filed on Mar. 31, 2009 entitled “METHODS OF OPERATING A TRANSPARENT TRADER”; and
3) 61/072,625 filed on Mar. 31, 2009 entitled “METHODS OF OPERATING A SURETY GUARANTOR FOR A CONTRACTS TRADER.”

### 1. FIELD OF THE INVENTION

The present invention relates generally to operating a contracts exchange system.

### 2. DESCRIPTION OF THE PRIOR ART AND RELATED INFORMATION

The Madoff pyramid scheme was made possible, at least in part, due to the lack of transparency in current securities exchanges and contracts exchanges. Current exchange systems are unable to detect the lack of trading and/or positions. Investors in traders are not able to obtain or see records that would indicate the lack of trading.

Similarly, current exchange systems were not able to detect the fictitious trades entered on the firm's books by an employee at Société Générale. No conventional systems to date allow for a firm, investor, regulator or third party to easily check records to determine such wrongdoing.

At AIG, the concentration of risk at this operation was not known outside of the firm. Because much of the risk derived from over the counter credit default swaps, there was not a single regulator, exchange, or counterparty which knew the full extent of their net positions. Since no other party knew the full extent of their positions, it was difficult to assess the true riskiness of dealing with AIG. After the problems became apparent, many counterparties were not only very concerned about AIG, but also were uncertain about whether other counterparties were in the same position.

### SUMMARY OF THE INVENTION

In one aspect, a preferred contracts exchange system is provided. The system includes a liquid contracts exchange. Shares of a trader trading on the liquid contracts exchange is listed on a securities exchange. A surety guarantees obligations of the trader. The system includes software which verifies holdings according to records of the trader, the surety, and the liquid contracts exchange all substantially match. A reporting mechanism provides real time surety pricing and computer accessible data of surety pricing. The surety may comprise an internal surety assuring timely payment of the obligations of the trader. An auditing mechanism provides data used in surety pricing. The auditing mechanism detects errors, fraud or concentration of risk and provides real time data.

In another aspect, a preferred method for transferring risk to capital markets uses the preferred contracts exchange system. The method comprises providing a contract, enabling the contract exchange system to determine that the contract is eligible, entering into the contract with the contract exchange system, transferring risk to a trader and transferring risk to an investor in the trader. The step of entering into the contract comprises unbundling financial rights and obligations of the contract from any surety guarantee or services called for by the contract. The step of entering into the contract comprises listing a share of the contract on a liquid contracts exchange. The method further comprises trading a share of the contract on a liquid contracts exchange. The method further comprises determining that the contract is standardized which may include determining that the contract is part of a set of standardized contracts. The method further comprises amending the contract after it has been entered into. The step of providing the contract comprises creating the contract, modifying an existing contract or renegotiating an existing contract already being traded on an exchange.

In a further aspect, a preferred method is also provided for operating a liquid contracts exchange. The method comprises qualifying traders to become eligible for trading on the exchange, trading on the contracts exchange using a computer or computer network by the transparent traders, providing a surety guarantee for each trader's obligations, and pricing each surety guarantee. The step of pricing each surety guarantee comprises obtaining relevant data, tabulating the relevant data using a computer or computer network, and generating reports of surety pricing. Obtaining the relevant data comprises obtaining information on surety premiums for the traders, and obtaining information on market values of assets and liabilities held by the traders. The step of generating reports of surety pricing comprises generating reports containing calculations of surety pricing in relation to each trader's assets and liabilities. The method further comprises monitoring a financial condition of each transparent trader, and restricting substantially all trading on the contracts exchange to transparent traders.

In a further aspect, a preferred method is also provided for paying an obligation under an contract traded on an exchange. The method comprises making a first payment required under a first contract to the exchange by a trader, and making a second payment under a related second contract to a third party which does not trade on the exchange. The first contract to the exchange comprises a share of a contract listed on a liquid contract exchange.

In a further aspect, a preferred exchange traded contract is provided. The contract comprises a first obligation to a holder of the contract to make a first payment to an exchange, and a second obligation of the exchange to make a second payment to a third party which does not trade on the exchange.

In a further aspect, an article is provided comprising a computer-readable medium that stores computer executable instructions for causing a computer system to receive input data including information pertaining to assets and liabilities of a trader, and facilitate charging for the surety guarantee in contemplation of the trader's assets and liabilities. The charges are publicly disclosed at stated intervals.

In a further aspect, an article is provided comprising a computer-readable medium that stores computer executable instructions for causing a computer system to tabulate total surety charges system-wide, tabulate subtotals for categories or groups, and calculate surety charges as rates. The rates are compared for at least two points in time. The rates are compared to rates charged for credit enhancement outside of the exchange. The surety charges may be calculated as rates to trader market value., as a percentage of market value of liabilities, or as a percentage of market value of trader equity.

In a further aspect, a method of auditing a trader is provided. The method comprises verifying substantially all the trader's positions by an exchange, and performing said verification at least once each trading day. The method further comprises disclosing audit results to a third party, disclosing only discrepancies or errors to a third party, confirming a book value of the trader by verifying the trader's positions and recent trading prices in said positions, comparing said book value to share prices of the trader's shares, recording audit results in a database that has results of a previous audit, determining that the audit has detected a prohibited condition; and forcing the trader to delist from the exchange or liquidate a position, displaying estimates of market value for a share from one or more sources, where said estimates are at a same point in time, and may be different from a most recent trading price, testing whether a trader's estimates of market value are significantly different from the exchange's estimate, and testing whether a trader's estimates of market value per share are significantly different from other traders' estimates.

In a further aspect, a preferred method of detecting errors, mistakes, or fraud in a trader's financial statements. The method comprises comparing positions on a trader's books to positions on the books of an exchange in real time using a computer or computer network, testing estimates of market value for said positions on the trader's books against data maintained by an exchange, and making information regarding compliance or discrepancies available in real time.

In a further aspect, a preferred method is provided for assuring compliance by a trader. The method comprises monitoring the trader's trading activities on an exchange using a computer or computer network, inhibiting the trader from trading in violation of legal restrictions of an exchange, inhibiting the trader from trading in violation of one or more self-imposed restrictions on its trades or positions, inhibiting the trader from trading in violation of surety restrictions imposed by said trader's surety, and requiring special approval from the exchange for a trade which would violate any said restrictions. The step of inhibiting the trader from trading in violation of one or more self-imposed restrictions on its trades comprises restricting the trader to trade only in assets which have a minimum value of zero. The step of inhibiting the trader from trading in violation of one or more self-imposed restrictions on its trades comprises restricting the trader's leverage ratio. The step of inhibiting the trader from trading in violation of one or more self-imposed restrictions on its trades comprises restricting the trader's maximum position in one or more contracts. The method further comprises reporting any attempted improper trades to a third party, disciplining the trader for attempting improper trades, denying a transaction if the special approval is withheld.

In a further aspect, a preferred computer system comprises a first data file of an inventory of a trader's positions according to an exchange, a second data file of an inventory of a trader's positions according to a trader, a third data file of an inventory of a trader's positions according to a surety, a computer-readable medium that stores computer executable instructions for causing a computer system to compare data from at least two of the first, second and third data files, and a fourth data file created by processing data using said computer-readable medium wherein said fourth data file contains a listing of discrepancies. The second data file is prepared by an underwriting manager.

In a further aspect, a preferred method of calculating book value of a trader is provided. The method comprises enumerating substantially all of a trader's positions at a given time, maintaining a database of transactions with trading data of the trader's positions, estimating a market price of each share of the enumerated positions, enumerating a market value of each of the enumerated positions, and totaling the market values to arrive at the book value. The step of maintaining the database of transactions with trading data of the trader's positions comprises including volume and price in the trading data. The method further comprises comparing the book value to a market capitalization of the trader.

In a further aspect, a preferred method of estimating a franchise value of a trader is provided. The method comprises calculating a market capitalization of a trader, calculating a book value of the trader, calculating any excess of market capitalization over book value, repeating the first three calculating steps at least one once at a different time to produce a time series of data records about the excess of market capitalization over book value of a trader, and estimating the franchise value of the trader using the time series data records of the trader. The method further comprises adjusting an estimate of the franchise value of the trader using the time series data records of a second trader.

In a further aspect, a preferred liquid contracts exchange comprises a computer or computer network that processes information about a share of a contract, a connection to a service provider identified in the contract, a connection to a clearing house, a connection to a data base on which resides information about a trader, and a data base or other record system on which resides information about a financial transaction relating to a share of a contract. The apparatus further comprises a computer-readable medium that stores computer executable instructions for causing a computer system to act as an exchange for trading by traders.

In a further aspect, a preferred method for making a contract tradable on an exchange comprises determining that a contract is standardized, listing the contract on the exchange using a computer or computer network, and omitting at least one conventional counterparty risk measure. The exchange may comprise a liquid contracts exchange. The step of determining that the contract is standardized comprises determining that the contract is part of a set of standardized contracts. The step of determining that a contract is standardized comprises determining that a substantially similar contract has been exchange listed. The step of determining that the contract is standardized comprises determining for a set of contracts that the set of contracts creates standardization for the contracts in the set. The step of listing the contract on the liquid contract exchange using a computer or computer network further comprises issuing at least one share of the contract to at least one trader on the liquid contracts exchange.

The step of omitting at least one counterparty risk measure further comprises listing the contract on the liquid contracts exchange without determining if the contract is likely to be actively traded outside of the contract exchange system or without imposing price change limits. The method further comprises dividing the contract into shares for trading by traders, promoting active trading on the exchange. The exchange may comprise an asset exchange. The step of omitting at least one counterparty risk measure further comprises determining that the contract is an asset, and determining whether or not to add a surety to the contract. The method further comprises generating reports containing information regarding trading, pricing and volume of the shares being traded.

The contract may comprises a loan contract. The method further comprises creating the loan contract between a lender and a first borrower, listing the loan contract on the exchange, and trading the loan contract on the exchange between the first borrower and a second borrower without permission from the lender. The method of further comprises increasing or decreasing a principal of the loan contract by any borrower at will. The step of trading the loan contract on the exchange between the first borrower and a second borrower without permission from the lender further comprises moving the loan contract among borrowers regardless of creditworthiness of the borrowers. The method further comprises creating the loan contract between a lender and an exchange, issuing shares in said contract, and trading said shares. The method further comprises making a payment under said loan contract by a trader, and providing surety to said lender.

In a further aspect, a method is provided for managing the trades of a trader trading in a contract exchange system. The method comprises valuing the trader's holdings using an algorithm residing on a hand-held device, computer or computer network, and trading on an exchange to improve the value of the trader's holdings. The valuing step further comprises using an algorithm that includes a charge for the trader's surety guarantee, or using an algorithm that provides a value that reflects a risk in the trader's holdings. The risk may be a timing risk, a scenario risk, a credit risk, an event risk or a currency risk. Data about surety pricing is used by the algorithm that provides a value that reflects a risk. The method further comprises trading only securities or contracts which are listed in the contracts exchange system. The method further comprises trading only on a liquid contracts exchange, trading only on an asset exchange, or trading only on a securities exchange listing trader shares. The method further comprises trading only contracts or securities specifically permitted by the contracts exchange system, trading only securities or assets which have a minimum value of zero, or trading only shares of transparent traders. The method further comprises auditing a balance sheet of the trader by the contracts exchange system, voluntarily restricting the trader's own trading, positions, or leverage with the exchange, requiring special permission to execute a trade which would violate said voluntary restriction, prohibiting transaction of a trade which would violate said voluntary restriction by the exchange, paying for surety by the trader, and calculating surety payments in consideration of positions, assets, or liabilities of the trader.

In a further aspect, a contracts exchange system includes a liquid contracts exchange, traders trading on the exchange, a securities exchange listing shares of the trader, thereby enabling access to the capital markets, and a surety guaranteeing obligations of the trader. Methods are provided for transferring risk to the capital markets, for operating a liquid contracts exchange, for paying obligations under an exchange traded contract, for calculating sureties, for auditing traders, detecting errors, mistakes or fraud in a trader's financial statements, for assuring compliance by a trader, for estimating a franchise value of a trader, for making a contract tradable on an exchange, and for managing traders in the contract exchange system.

### BRIEF DESCRIPTION OF THE DRAWINGS

FIG. 1 is an overview of the parties involved in a contracts exchange system.

FIG. 2 is an overview of how a contracts exchange system might provide real time indications of the pricing of a surety guarantee, and of the total surety pricing for the system.

FIG. 3 is an example report of surety income for a particular surety provider.

FIG. 4 is a diagram showing how contracts become tradable on a contracts exchange system.

FIG. 5 is a diagram of methods of detecting error, fraud, and concentration of risk.

FIG. 6 is a diagram showing how assets become tradable on a contracts exchange system.

FIG. 7 is a diagram showing how liquid loan contracts can be issued by a contracts exchange system.

FIG. 8 is a diagram illustrating how a contracts exchange system can operate as a central bank.

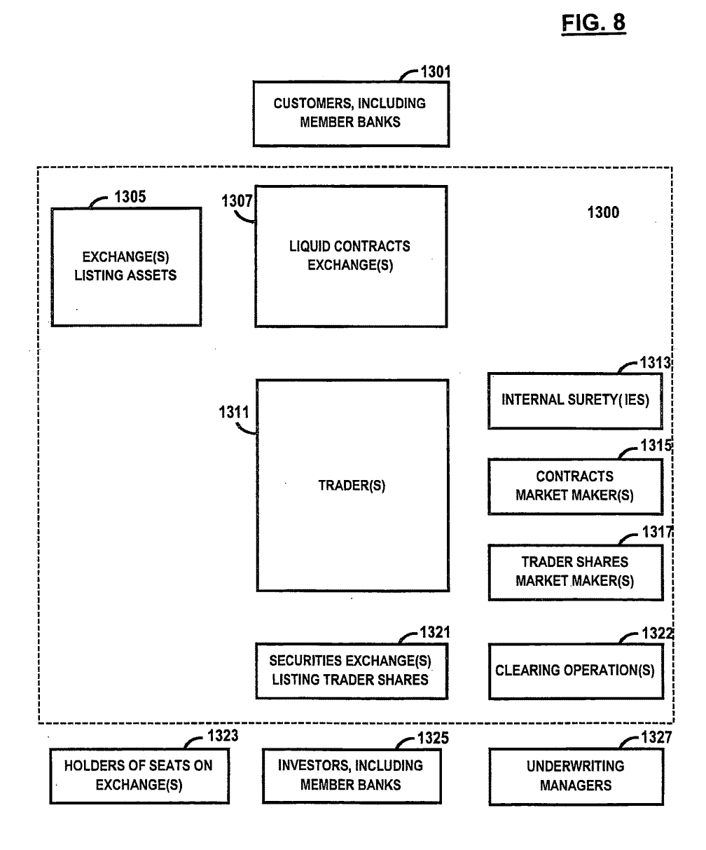

FIG. 9 is an exemplary display of aggregate surety fees over time for a contracts exchange system.

FIG. 10 is a chart illustrating the book valuations for three assets which might be carried on a closed end fund's balance sheet over a single month.

FIG. 11 is an exemplary display of assets, liabilities, and other commitments of a transparent trade.

FIG. 12 is an exemplary income statement for a transparent trader.

FIG. 13 is a listing of some items which would never be found on a transparent trader's balance sheet or income statement.

### DETAILED DESCRIPTION OF THE PREFERRED EMBODIMENTS

The various embodiments can now be better understood by turning to the following detailed description. It is to be expressly understood that the illustrated embodiments are set forth as examples and not by way of limitations on the invention as ultimately defined in the claims.

A contracts exchange system that operates without at least one of the conventional risk management measures used by futures exchanges may use many well-known methods used by futures exchanges (such as charging a fee for consummating a sale) and also has many possible novel methods and sources of income.

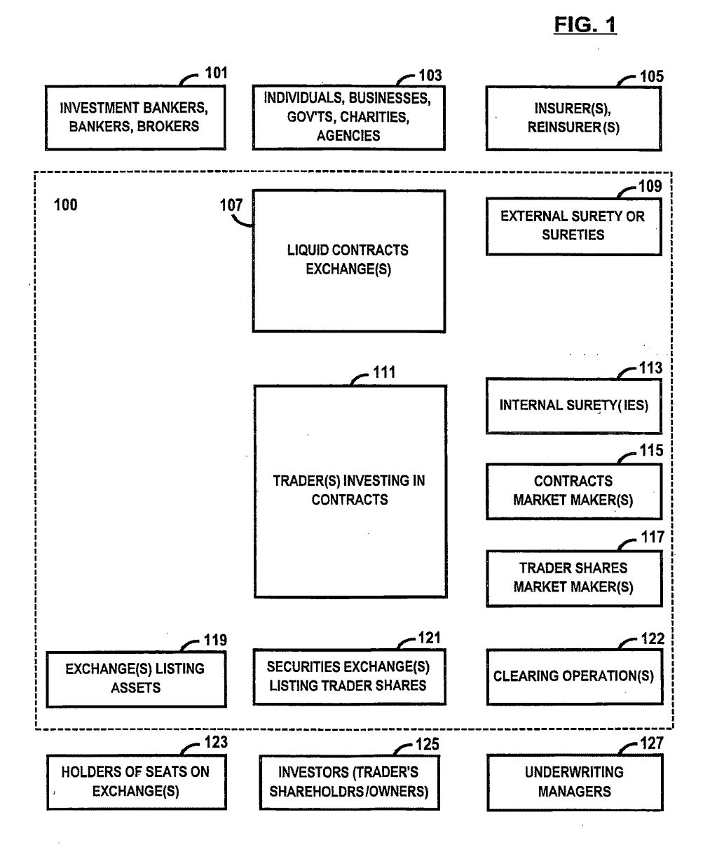

The two exchange system/apparatus shown in FIG. 1 creates value by creating liquidity and market prices for contracts, including surety guarantees, shares in traders, and other assets. Market prices have demonstrated their value in many ways, not the least of which is that international and national accounting standards have adopted “marking to market” using current market data as the “gold standard” for valuation methods. The owners, officers, employees, and independent contractors to a contracts exchange system can reap a part of the value that it creates.

FIG. 1 is an overview of the parties involved in a preferred embodiment of a contracts exchange system 100. Parties involved with a contracts exchange system 100 include: investment bankers, bankers and brokers, including for example stockbrokers, insurance brokers, and reinsurance brokers 101; individuals, businesses, governments, government agencies, and charities 103 which are external counterparties which have contracts with the contracts exchange system 100 either directly or via one or more insurers or reinsurers 105.

On existing futures exchanges, money is transferred between members of the exchange (or those trading via members). For every dollar received by one member, a dollar is paid by another, plus, of course, expenses. One novel feature is that the contracts exchange system acts as the counterparty to the outside party 103 or its insurer or reinsurer 105. For example, if a contract is listed for Allstate private passenger auto, money could initially flow from Allstate to traders assuming the contract, and over time as losses materialize money could flow from traders to Allstate via the exchange. Another example is a liquid loan contract, where money is lent to the contract exchange system (and ultimately to traders) by lenders outside of the contracts exchange system, and repaid to outside lenders by the contracts exchange system.

In the preferred embodiment, the parties inside of the dashed line are regulated and/or controlled by the Contracts Exchange System, or simply Apparatus, 100: one or more Liquid Contracts Exchange(s) 107; one or more external sureties 109, providing assurance of payment to outside entities, such as individuals, businesses, governments, government agencies, and charities 103; one or more traders trading in contracts 111, such traders might be transparent traders if they hold substantially all liquid assets and/or liabilities, as described in more detail in a related application (U.S. patent application Ser. No. 12/075,597, the disclosure of which is incorporated herein by reference); one or more internal sureties 113, which provide assurance of timely payment to parties within the Contracts Exchange System, including traders 111, contracts exchanges 107, and contracts market makers 115 through the clearing operation(s) 122. The term “trader” as used throughout this specification may also refer to a “transparent trader” if substantially all of said trader's holdings comprise liquid assets and/or liabilities, preferably exchange traded.

Shares in traders 111 are traded on one or more securities exchange(s) listing trader shares 121, and there may be one or more trader shares market maker(s) 117. Trader(s) trading contracts 111 are managed and/or controlled by one or more underwriting managers 127. One or more contracts market maker(s) 115 and one or more trader shares market maker(s) 117 may be traders 111, the Contracts Exchange System itself, or special-purpose entities. One or more exchanges may list assets 119, with said assets always having a value of zero or greater (similar to stocks and bonds on existing exchanges). Investors 125 in trader(s) 111, buy and sell shares of said trader(s) on one or more securities exchange(s) listing trader shares 121. One or more clearing operations 122 clear trades on liquid contracts exchange(s) 107, exchange(s) listing assets 119 and securities exchange(s) listing trader shares 121. Potential clearing operations include, but are not limited to: third party firms, a direct subsidiary of an exchange, a sister company of an exchange, a partnership of more than one exchange. There may be holders of seats on one or more exchanges 123. A seat might entitle a holder to trade on a liquid contracts exchange 107, a securities exchange 121, an asset exchange 119, or various combinations thereof.

One or more internal surety(ies) 113 might guarantee that traders 111 will fulfill their financial commitments. One or more external surety(ies) 109 might enhance the credit rating of the System with respect to a particular contract. Such credit enhancement might be useful for many types of contracts, including insurance, reinsurance, commodity futures, precious metals, interest rate swaps, credit default swaps, loans, or other contracts potentially requiring payment to parties outside of the contracts exchange system. An external surety might enhance the credit or assure the performance of an outside party 103 that might be a creditor of the contract exchange system 100.

In alternate embodiments described below, some parties are not under the regulation and/or control of the contracts exchange system 100. Also in alternate embodiments, some parties might be combined, or might not exist at all.

### Alternate Embodiments Related to FIG. 1

Parties listed in FIG. 1 might vary in the following ways (many other permutations are also possible):

1. An exchange listing assets 119 may be independent of the contracts exchange system. In that case, the system may have restrictions on characteristics of assets which could be held by traders trading contracts 111; for example, the currency in which assets are denominated, market capitalization, liquidity calculations, exchanges on which assets are traded, indexes which assets are a part of, or types of assets (e.g., real estate or venture capital might be prohibited). Alternately, the system could have a listing of individual securities allowed (e.g., individual stocks, denoted by CUSIP). Such a listing may change over time due to initial public offerings, mergers, acquisitions, bankruptcies, and other factors. An exchange listing assets 119 may be required to avoid listing shares of traders trading in contracts 111 (which would be traded on the securities exchange(s) listing trader shares 121), or to avoid listing contracts which are traded on a liquid contracts exchange 107.
2. A contracts exchange system might allow traders to hold both assets listed within the Contracts Exchange System and other assets that fit certain restrictions. This could be a permanent arrangement, or could be used as a start-up contracts exchange grows, eventually transitioning to a preferred system of having all assets owned by traders trading under the regulation and/or control of the contracts exchange system.
3. Seats on exchange(s) 123 might not exist, or might be identical to being a trader trading contracts 111.
4. The exchange itself could perform the entire external surety function 109, eliminating the need for third party external sureties. For certain contracts, there may be no need or desire for external surety. For example, trading in contracts based upon indexes may not have any counterparties external to the contracts exchange system.
5. The exchange itself could perform the entire internal surety function 113, eliminating the need for third party internal sureties.
6. Contracts market makers 115 might not exist, or a similar function might be served by specialists, similar to the role currently served by specialists on the New York Stock Exchange.
7. Trader shares market makers 117 might not exist, or a similar function might be served by specialists, similar to the role currently served by specialists on the New York Stock Exchange.
8. The exchange(s) listing assets 119 might not have a separate existence. Its functions might be performed by the contracts exchange 107, or the securities exchange(s) listing trader shares 121.

Nothing prohibits or limits the operation of multiple contracts exchange systems. For example, different contracts exchange systems might clear trades in different currencies; might be located in different countries, states, or jurisdictions; might have different rules; or might have different specialties (e.g., commodities, foreign exchange, property casualty insurance, credit risk, interest rate risk, or surety).

It is entirely possible that local regulations would be sufficiently different that using a single contracts exchange system across two or more jurisdictions could be prohibitively expensive, far less efficient than multiple exchange systems. It is also possible that features other than local regulations could make compliance more difficult than multiple contracts exchange systems.

Multiple contracts exchange systems might have many of the same participants or vendors. For example, many of the same investors might own shares in traders on multiple exchange systems. A single firm might provide surety on more than one exchange. A single insurer might cede risk to different exchange systems.

In some cases, essentially identical contracts might trade on multiple contracts exchange systems. This might occur if at least one exchange did not have sufficient capacity or interest for the entire amount of risk which an outside party might wish to cede.

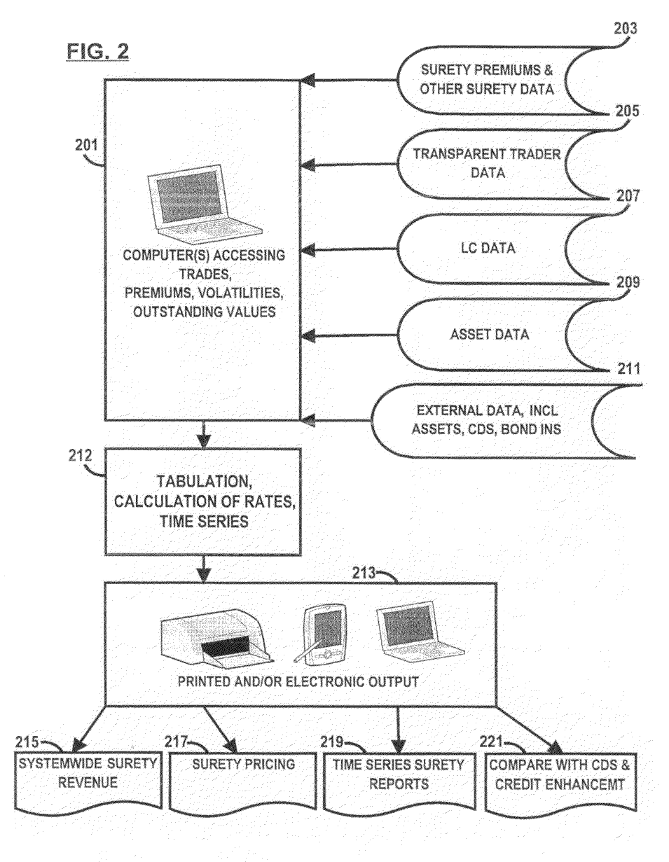

FIG. 2 is an overview of how a contracts exchange system can report on surety pricing including the total surety pricing for the system. This provides types of information which either do not exist, or are impossible to obtain in real time for current exchanges. Such information includes: system-wide risk metrics, surety cost metrics, and time series data, any of which can be tabulated in real time or episodically.

Information on surety fees over time can reveal: trends in asset volatility (e.g., stock and bond markets); changes in the mix of contracts (e.g., from more stable contracts such as auto physical damage or medical costs, to more volatile contracts such as hurricane coverage and electricity prices); changes in leverage of the entire system; changes in credit risk of the entire system; changes in surety pricing or availability (e.g., more qualified sureties becoming available).

Turning now to FIG. 2, one or more computers 201 access trades, surety premiums, volatilities, and outstanding values for contracts, assets, and shares in traders which are traded on the contracts exchange system. Inputs include: surety premiums and other surety data related to the contracts exchange system 203; trader data 205, including positions, trades, and current trader share prices; liquid contract data 207, including trading prices and number of shares traded, total outstanding shares, and current holders of those shares; asset data 209, for assets with a minimum possible value of zero which are traded in the contracts exchange system, including trading prices and number of shares traded, total outstanding shares, and current holders of those shares; and data on assets traded outside of the exchange (if traders and/or sureties are permitted to hold outside assets), credit default swap information (e.g., history of CDS rates) for counterparties interacting with the contracts exchange system, and bond insurance data 211.

Input data from 201-211 is tabulated at step 212. Such tabulation might occur on a continuous basis, or episodically (e.g., hourly, daily, weekly, monthly, quarterly, annually). A vast number of rates, trends, comparisons, and time series can be output, to printers and/or electronic media 213, and displayed via computers, handhelds, cell phones or other portable computing devices. Such reports could be created for: individual sureties; groups of sureties or traders; for certain types of instruments; for the contracts exchange system as a whole; for multiple contracts exchange systems consolidated together, and for any or all of the surety functions described above.

Examples of measurements of surety pricing include: total surety fees per day, week, month, or other unit of time 215; surety pricing as a percentage of market value of liabilities, or as a percentage of market value of trader equity, or as a percentage of trader share market value 217. Any of the ratios can vary with time, and time series reports can be created 219. A time series of such ratios can provide information on how the risk of the system is changing over time. Surety pricing might also be compared to credit enhancement fees being charged outside of the contracts exchange system 221. For example, for a particular bond which is owned by the contract exchange system, bond insurance rates charged outside the exchange might be different than surety rates charged within the system.

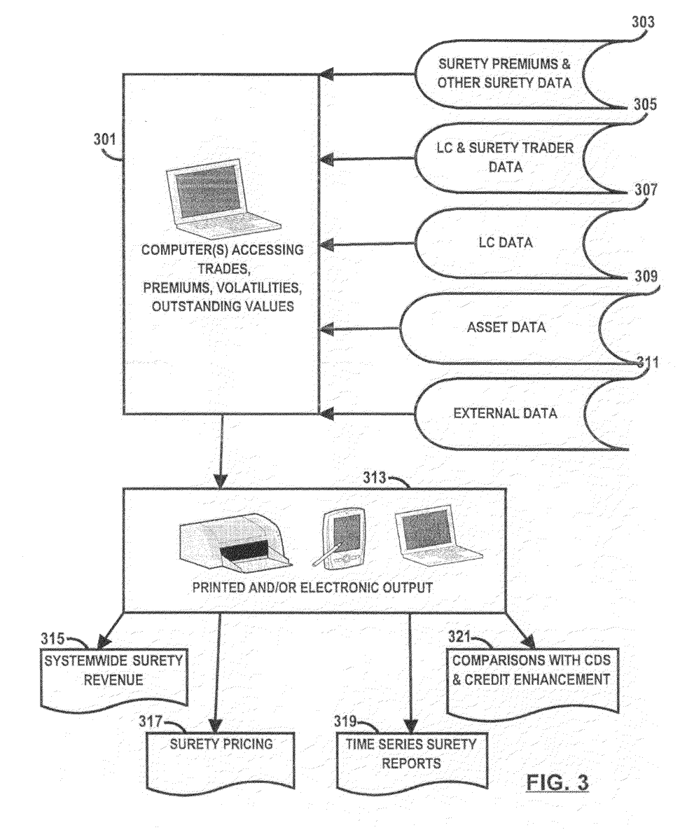

FIG. 3 is an example of a summary of trader information and surety fees for a particular surety firm operating on a contracts exchange system. The summary of information may be displayed in many permutations of the content and format shown in this example. A significant data field displayed in FIG. 3 is the time stamp. Such a report may be distributed at any time, not just when the books are closed monthly or quarterly. The source data may be read in real time, as described above, so the time stamp is an important new feature of a summary of the pricing and risks of surety guarantees.

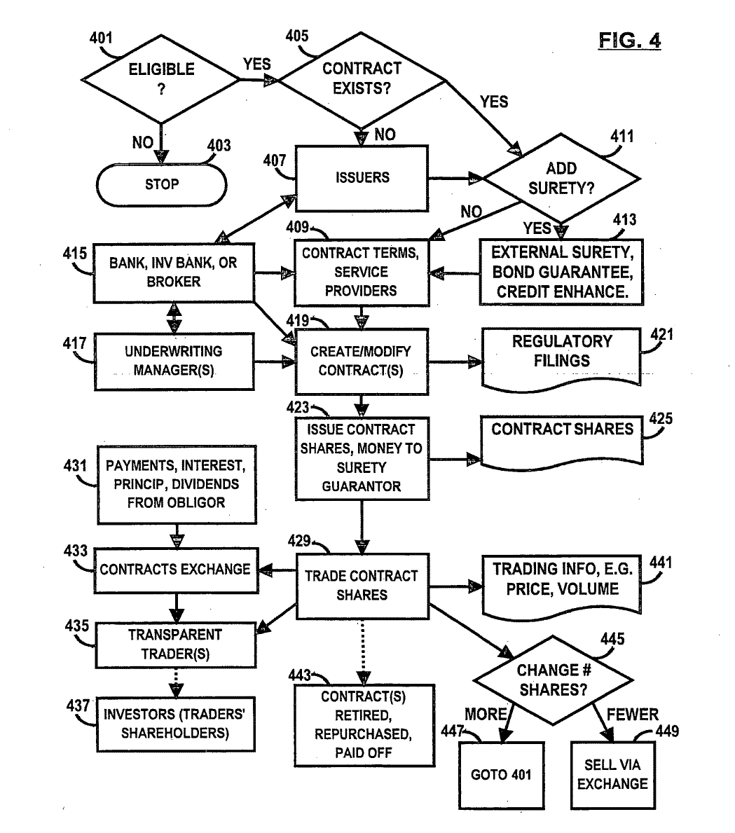

FIG. 4 is a diagram showing a preferred method of how contracts become tradable on a contracts exchange system. Persons familiar with the listing of contracts on a commodity futures contract exchange such as the Chicago Mercantile Exchange will observe a number of differences between the methods used by futures exchanges and the method enabled by the contract exchange system. Contracts may have values that are greater than zero, less than zero, or than vary from less than zero to greater than zero.

Until the contract exchange system, contracts considered for trading by a commodity futures contract exchange were screened for eligibility using a range of tests, two of which are not required by the preferred system described herein. One test is to be confident that the contract would be frequently traded. For example, futures for soy beans are listed and are frequently traded. Other examples of agricultural commodities that are frequently traded are corn, wheat, soybean oil, sugar, coffee, cocoa and cotton. Contracts that are not likely to be frequently traded are not eligible. For example, there is no contract for pomegranate juice.

A second test is to be confident that the price will not be too volatile. Commodity futures exchanges require margin accounts. An investor's margin account may become depleted if a contract's price increases or decreases. In such a situation, the investor is typically required to replenish the margin account by the beginning of trading on the following day. Daily price change limits and position limits are imposed by a futures exchange to make it unlikely that a margin account will be completely wiped out before it can be replenished. Contracts that are expected to reach their daily price change limit frequently are not listed on a futures exchange.

Neither of these tests is relevant for the contract exchange system. As discussed at FIG. 1, the contracts exchange system 100 may aggregate the wealth of traders trading in contracts 111 to bear risks of financial loss arising from contracts listed on the liquid contracts exchange 107. The entire contracts exchange system 100 may act as the counterparty to any contract listed by an individual, business, government, charity or other legal person 103. Once listed, active trading of shares can be promoted by the methods described U.S. patent application Ser. No. 12/075,597. To the extent that such trading does not involve using margin accounts, position limits or daily price change limits and is active, it will provide for price discovery even if similar contracts are not trading on other futures exchanges. Trading data can be read from databases maintained in distributed processing centers spanning the globe, and can be read by any capable device such as a computer, mobile phone, personal digital assistant, message exchange system, router or server. Rules, regulations, statutes and laws about trading also can be maintained and made accessible in a modern system of information technology.

The second test, that price not change too quickly is also not relevant for a contracts exchange system. For example, a contract listed by a reinsurer 105 may change in price tenfold in a matter of hours. Once listed on the liquid contracts exchange 107, active trading of shares can be promoted. To the extent that such trading does not involve using margin accounts, position limits or daily price change limits and is active, it will provide for price discovery even if similar contracts are not trading on other futures exchanges. Moreover, to the extent that the contracts exchange system is operated continuously without interruption on computer systems globally with information conduits refreshed several times per second, the price discovery may reflect upward and downward price changes at the rates of hundreds of percent per minute and extensive rearrangement of the holding of the shares of such a contract by the traders 111. Data about such changes can be read from databases maintained in distributed processing centers spanning the globe, and can be read by any capable device such as a computer, mobile phone, personal digital assistant, message exchange system, router or server.

Because two of the major constraints on the successful listing of contracts on futures exchanges are not relevant, the diversity of contracts that can be successfully listed on a contracts exchange system is many times greater than on futures exchanges. Investment bankers, bankers and stock brokers, insurers and reinsurers and individuals and businesses of many types may bring contracts to the contracts exchange system even if they are not expected to trade actively as contracts and even if they may experience rapid changes in prices.

An important quality of many useful contracts is that their price depends on some natural or man-made event. Consider the price of electricity in Chicago during the eighteenth hour of the twenty-fourth day of January, 2013. The price of a contract for a megawatt-hour may depend on business conditions, the elections in 2012, weather conditions, terrorist acts, and myriad other factors. As of January, 2008, the price may be volatile because of the five years that will pass before the electricity is delivered. The price may be essentially unchanged throughout the first nine months of 2012 if there is no “news” affecting the price. The price may again be volatile between January 3 and Jan. 22, 2013, as events change quickly. During all of this time there may be little trading activity in such a contract because the expertise to forecast these events is held in disparate sources. Such contracts are not suitable for commodities futures exchanges. They may be listed with a contracts exchange system according to the invention.

In this sense the preferred contracts exchange system is like a single counterparty to a contract, like a large, publicly disclosed fund. The capability of a specific trader to pay its debts is paramount to a futures exchange. But the capability of the entire contract exchange system is paramount to a contracts exchange system as it may be the sole counterparty in a contract-brought to the system. Just as Berkshire Hathaway may enter into a contract that no other firm trades, so a contracts exchange system may enter into a contract that no other firm trades.

An important test for eligibility that was developed for commodity futures exchanges also applies to a contracts exchange system, which is, that the exchange may choose not to enter into the contract if it is not standardized or capable of standardization. Continuing with the example of a contract for electricity delivered in a given hour on a given grid, it is readily understood that similar contracts could be listed for other grids in other cities and at other times and other hours. These contracts may be created as a series, or a contract may be brought to the contract exchange system from time to time; the quality of standardization is that there is enough similarity to the various contracts that price information can be inferred for one contract from data about another. Like the process of triangulating in navigation, this method is well known by persons with skill and experience trading contracts. This process of triangulation allows arbitrage opportunities to be identified and turned into trading activity. It also allows traders to hold small positions in a great variety of contracts in order to gain the benefits of diversification and other benefits of portfolio management, again leading to trading activity. As a result, unique risks (such as Lloyds of London's insurance policy on Betty Grable's legs) may be rejected by the contracts exchange system. This test for eligibility may be appropriate for a proposed contract even if it is not appropriate for each and every contract.

With this understanding of the differences between a commodity futures exchange and a contract exchange system, FIG. 4 describes the process of making a contract tradable on a contract exchange system. At step 401, the contract is determined to be eligible, or the process goes to a stop at 403. If the contract is determined to be eligible, the decision moves to whether the contract already exists 405, and if not, the contract between one or more outside parties 407 and the contract exchange system is created with the skills of bankers and brokers (including for example investment banks, banks, central banks, real estate brokers, stock brokers, commodity brokers) 415 in consultation with one or more underwriting managers 417. Underwriting managers 417 may play the roles played by lead underwriters in investment banking, real estate syndication and insurance underwriting, setting tentative prices for the bankers and brokers 415 to take to the contract exchange system. Optionally the outside party or existing contract may by a decision at 411 receive or provide a credit enhancement, financial guarantee, performance bond or other surety document 413 from a surety. The existing or draft contract terms 419 are filed with a regulator or other party if appropriate by a paper or electronic filing 421. Upon the completion of any modifications to the outward contract in step 419, the activity is to issue the shares in step 423.

In step 423, the contract, or a series of related standardized contracts, is divided into shares for trading on a contracts exchange 433. As identified in FIG. 1, this contracts exchange may be a liquid contracts exchange or an asset exchange. Also in step 423, any surety guarantee is unbundled from the financial obligation, the shares are issued to the initial subscribing traders, and any initial cash payments are made pursuant to the contract(s). Contract shares may be recorded on paper or may be documented solely in data bases on computers or virtual means 425. In the event that less than all of the shares are issued to initial subscribing traders, step 423 would also include an auction or other contractually provided means of ensuring that all of the shares are issued contemporaneously, including having an underwriting manager underwrite any shares not taken by the initial subscribing traders. Funds may be transferred in step 423. The use of clearing houses (or bank accounts) in this process is obvious to one familiar with clearing (or banking) and is not shown in FIG. 4 in order to highlight the operation of the contract exchange system.

Following step 423, the shares of the contract are traded on a contracts exchange or asset exchange 433 by traders 435; such trading may consist entirely of the execution of algorithms on computer systems subject to communications arriving electronically or by other media. Trading information 441 is collected and output, including price, volume, time of trade, and the identities of the traders and sureties involved. Some trading information may be made available to anyone; access to other information may be restricted. For example, the identities of which traders participated in particular trades might be available only to those traders, their sureties, and the liquid contracts exchange.

Some contracts will provide for the receipt of interest, principal, dividends, or other payments from an outside obligor 431. Examples include a bond issued by an outside firm and traded on the exchange, a futures contract between the contracts exchange system and an outside firm, and premiums for ongoing reinsurance coverage provided via the contracts exchange 433. Such payments 431 are divided by the number of outstanding contract shares of the corresponding contract(s) on the contract exchange, and distributed to the traders 435 owning said shares. Traders may pay dividends, buyback shares, or provide other forms of return of capital to investors 437.

Many contracts will have an expiration date among the contract terms defined in step 409. For example, a future contract for pomegranate juice might expire Jan. 14, 2011. Other contracts will have a maximum payout which is reached. For example, a credit guarantee might pay up to $10,000 per share in the event of a loss of a particular credit rating. Other contracts might have little or no value for other reasons. In such cases, a contract may retired, repurchased, paid off or otherwise removed from the contract exchange system entirely 443.

A number of contracts will be a series of contracts, such as pomegranate futures with monthly expirations. Each month, one contract could expire and a new contract could be listed. Contracts might tend to be underwritten serially because of the importance of the test for standardization discussed above.

This also provides a novel way in which the number of shares might increase or decrease on a contracts exchange system. If there is a desire to change the number of shares of a contract trading on the contracts exchange system 445, more shares could be added by repeating the process starting at 401. In many cases, the process would move very quickly with essentially identical arrangements to the initial share offering. It is possible that position limits, counterparty risk, or some change in law or policy since initial issuance would require changes, or prohibit additional issuance. Of course, it is also possible that the outside counterparty is unable or unwilling to increase the contract value. For example, if Allstate had already ceded 100% of its California private passenger auto risk into the exchange, it cannot increase the contract value.

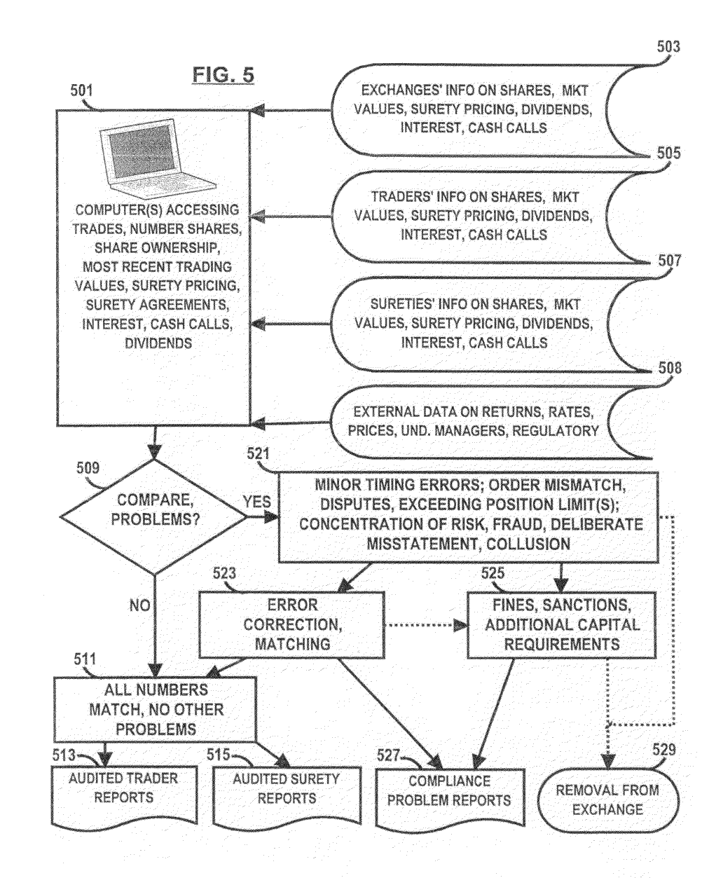

There might also be a desire for fewer shares of a contract on the contracts exchange system 449. Shares might be sold via the contracts exchange system to outsiders. For example, an outside party which had a contract regarding pomegranate futures might be willing to reduce the size of the contract. That would allow fewer shares to be listed. Another example involves “mirror assets”, discussed in FIGS. 5 & 6. If an asset is listed on the contracts exchange system and another exchange, the price might be higher on one of the two exchanges. If the contract has a positive value and the price is higher elsewhere, traders could sell shares via the contracts exchange system and make a profit.

FIG. 5 is a diagram of a preferred method 500 of detecting error, fraud, and concentration of risk.

The contracts exchange system provides unique opportunities to detect and deal with:

1. Misstating the number of shares of a particular contract or security which a trader holds.
2. Misstating the market value of shares or most recent trading prices.
3. Misstating surety pricing, capacity or agreements.
4. Misstating trading volume or liquidity.
5. Excessive concentration of risk.

Three recent financial scandals would have been either impossible or easily detected with this method:

A. The Madoff pyramid scheme is estimated to have cost investors $50 billion. The

Madoff scheme would have been impossible for a trader trading in contracts. It is alleged that for a number of years no actual trades were made. http://online.wsi.com/article/SB123655521154265891.html#project %3DMADOFF BUILDING. If a trader's management attempted to manage a pyramid scheme with no actual trading, the contracts exchange system would detect the lack of trading and/or positions. Investors in the trader would be able to see both that the contract exchange system's records did not match the trader's statements, and that compliance problem reports were being generated. Such problems would likely quickly result in strong sanctions and being shut down or liquidated by the exchange.

B. The Société Générale problem with fictitious trades [see for example, The New York Times, Jan. 25, 2008] entered on the firm's books by an employee would have been easily detected by the contracts exchange system, the firm, and/or the surety. If a trader, its surety, the exchange, an investor, or a regulator ever doubts its own books, the trader's entire positions and trading history for all types of contracts and securities are retained on the contracts exchange system's computers.

C. AIG Financial Products [see for example, “Regulatory Oversight and Recent Initiatives to Address Risk Posed by Credit Default Swaps”, United States Government Accountability Office, Mar. 5, 2009], The concentration of risk at this operation was not known outside of the firm. Because much of the risk derived from over-the-counter credit default swaps, no regulator, exchange, or counterparty knew the full extent of any net positions. Since no other party knew the full extent of their positions, it was difficult to assess the true riskiness of dealing with AIG. After the problems became apparent, many counterparties were not only very concerned about AIG, but also were uncertain about whether other counterparties were in the same position. In the preferred embodiment, the contracts exchange system will be able to monitor concentration of risk in real time, and might have a policy of publishing such information. Concentration of risk would affect surety pricing. The contracts exchange system might have risk policies and/or position limits to reduce the dangers which could be posed by too much concentration of risk.

Turning now to FIG. 5, one or more computers or computer networks 501 used by the exchange accesses information about trades, number shares, share ownership, most recent trading values, surety pricing, surety agreements, interest rates, cash calls, dividends, and other information related to the contracts exchange system, sureties, and traders.

In the preferred embodiment, all contracts, securities, and assets held by traders are traded on the contracts exchange system. In that case, all trades have been cleared by the contracts exchange system (or its clearing operation). In an alternate embodiment, some contracts, securities, or assets may be traded and cleared elsewhere. In that case, the exchange (or its clearing system) will received data on trades cleared elsewhere. The data according to the contracts exchange system's records 503 includes number of shares, most recent trade prices, surety pricing, dividends, interest, and cash calls. Similar information from the traders is collected 505. The exchange may also collect similar data from traders' sureties 507.

A broad variety of external data may be collected 508, including: data on securities and other assets outside of the exchange (e.g., stocks, bonds, reits); interest rates, exchange rates; rates of return on various classes of securities or investments; information on underwriting managers, including any legal or regulatory action against one or more underwriters and whether an underwriter has indications of material financial problems.

At 509 the datasets are compared and checked for other problems. Comparisons include:

1. Do the current numbers of shares match for all contracts, securities and assets in a particular trader's portfolio?
2. Do the most recent market trade prices match?
3. Do all of the trades made in a recent period of time (e.g. day, week, month) by this trader match?
4. Do all payments and receipts of interest match?
5. Do all dividend payments and receipts match?
6. Do all cash calls match?
7. Do surety premiums match?
8. Are there any legal or regulatory actions against an underwriter which warrant a higher level of attention or more information?

In addition, the contracts exchange system may have standards, policies, or regulations which it creates or is required to enforce. For example, it may require that no more than a certain portion of particular contracts are owned by a particular trader. It may have maximum leverage or minimum capital requirements. It may wish to avoid too much concentration of surety in a particular surety firm.

If all numbers match and there are no other problems (such as position limits, concentration of risk, or concerns regarding underwriting managers), a no continues the process at step 511. One or more computers is used to print or display a variety of reports which can be produced, including audited trader reports 513 and audited surety reports 515. An audited trader report could provide verification that the trader indeed owns the number of contracts, securities, and assets which it states, and that its stated fees to the sureties and the exchange are correct.

Such audits of all of each trader's positions, trades, and fees by the exchange listing the trader is not disclosed by prior art. For example, members of the New York Stock Exchange do not have their entire financial statement audited by that exchange, nor do members of the Chicago Mercantile Exchange.

Transparent traders offer yet another audit possibility that is not disclosed by prior art. Requiring that transparent traders have only liquid contracts, securities, and other assets which are liquid and which have market values makes such an audit possible with great frequency, possibly even in real time. Such verification can be very useful to investors, other traders, sureties, counterparties of the exchange system who have ceded risk into the exchange, regulators, and the public.

There are numerous potential errors, discrepancies, compliance problems, and even some forms of fraud and collusion which might cause problems at 509. If “yes” the process continues to 521, where such problems are investigated. Computer software can automatically produce a listing of many problems or potential problems.

Many differences in data in the various systems will be slight differences in timing or reporting. This would be more likely at times with very heavy trading volume, or if the datasets include trades cleared outside of the contracts exchange system. For many purposes, the process in FIG. 5 could be run on a slight time delay, or during times which are normally expected to be low trading volume (e.g., 2 am local time for a major time zone in the country where the exchange is organized).

Mismatched orders and disputes happen in most (if not all) current trading and clearing systems. Similar resolution processes to those employed by existing exchanges and clearing operations could be used by the contracts exchange system.

Some forms of collusion can be detected. Unusually heavy trading, especially between traders run by the same underwriting manager, can be detected. Some contracts traded on the contracts exchange system will have “mirror assets”, or very similar contracts traded elsewhere. Unusual price and volume behavior on the contracts exchange system versus similar contracts elsewhere may raise red flags.

Fraud and/or deliberate misstatement of positions, recent trades, or recent trading prices by a trader could result in strong actions by the contracts exchange system, regulators, or law enforcement. Such behavior by traders (or trader's management) might result in fines, sanctions, or additional capital requirements 525.

A high rate of disputes or errors by a trader (or its management) might also result in fines, sanctions, or additional capital requirements 525.

All problems detected in 521 are summarized in one or more compliance problems reports which are printed or displayed on electronic media 527. All or part of such reports might be available to the public, might be restricted to members of the exchange, or might be accessible only to the exchange.

In some cases, problems with a particular trader, their data systems, their managers, their concentration of risk, financial condition, or other factors, may be sufficiently severe, repeated, or longstanding that the trader is removed from the exchange and its positions taken over by another party or liquidated 529.

Note that being removed from existing commodities, futures, or stock exchanges does not cause the dissolution of the member or listed firm. In the preferred embodiment, removal of a trader from the contract exchange system requires that it either be taken over, liquidated, or dissolved. This is not a practical problem, however. Indeed, as evidenced by the recent problems with institutions that seemed “too big to fail”, it is far better to have both ease of entry and ease of exit of the traders. The removal from the exchange by merger, liquidation or dissolution might be a mechanical process. Troubled traders might be subject to buy-out by market makers for their shares or by their internal surety. Also, underwriting managers may be able to set up new traders fairly simply. As a result, a single contracts exchange system might have hundreds or thousands of traders and a turnover of several traders each month. This is desirable for the same reason that society is less troubled by the closure of a single car dealership than by the closure of General Motors.

In a preferred embodiment, many of the contracts traded on the contracts exchange system will be assets of the system and of the traders trading in the contracts. For example, when a trader begins operations its clearing account may show only cash; to the extent that it takes on liabilities, it will have even more cash. Therefore, as a group the traders will want to have a number of contracts which by their terms are assets whose value cannot drop below zero.

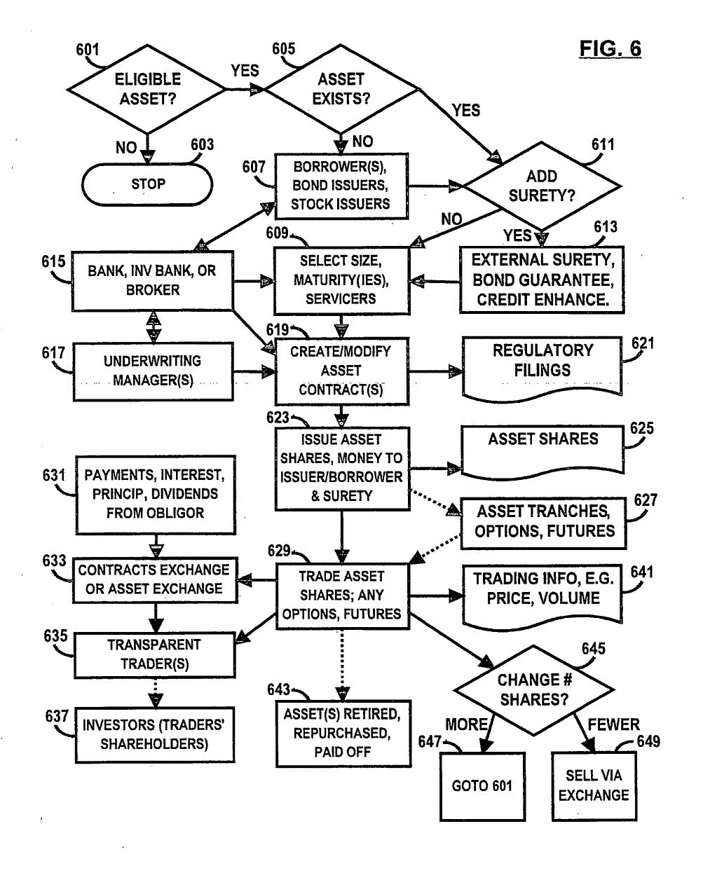

FIG. 6 is a diagram showing a preferred method 600 of how assets become tradable on a contracts exchange system. FIG. 6 refers to assets which are traded on the contracts exchange system itself, and whose value cannot drop below zero.

As mentioned above, a contracts exchange system might also allow traders to hold assets which are not traded or cleared on the contracts exchange system. However, such assets would not follow the same process as FIG. 6, since those assets are not, and are not expected to be, listed on the contracts exchange system.

The process 600 in FIG. 6 starts with a review of whether a proposed asset is eligible at 601. A contracts exchange system may set a number of conditions, qualifications, or exclusions for eligible assets. Potential screening might include: currency in which the asset or its payments are denominated, total amount outstanding or proposed (small asset values might not maintain liquidity), financial condition of issuer, avoiding assets with high potential for manipulation by issuer or current owner, clear disclosure, good legal standing of issuer(s), any potential regulatory problems, no restricted stock, or no private equity. If the asset does not pass the eligibility screening 601, the process stops 603. If the asset passes eligibility screening, the process continues to 605.

An asset might be created specifically for a contracts exchange system. For example, a Catastrophe Bond might be issued directly into the contracts exchange system. If an asset already exists the process branches to 611, a decision is made regarding whether to add surety 611 to the existing asset. For example, a municipal bond might have a bond guarantee added to it for trading on the exchange. A second example might be adding a credit enhancement to a large bank loan which will be traded on the exchange. If some form of external surety, bond guarantee, or other credit enhancement will be added, a “yes” causes the process to continue to 613, and then to 609 where contract size(s), maturity(ies) and servicer(s) are determined. A “no” at 611 proceeds to 609.

An existing asset which does not have any surety, bond guarantee or credit enhancement might be called a “mirror asset” on the contracts exchange system. Such an asset might have substantially identical characteristics to assets traded outside of the contracts exchange. However, assets traded on the contracts exchange would often provide more liquidity and more frequent trading information.

If the asset does not yet exist, a no at 605 continues the process to 607 where borrower(s), bond issuer(s), stock issuer(s), or other parties originating assets decide whether their newly issued assets will have any added surety 611. If some form of external surety, bond guarantee, or other credit enhancement will be added, a “yes” causes the process to continue to 613, and then to 609 where contract size(s), maturity(ies) and servicer(s) are determined. A “no” at 611 proceeds to 609.

At 609 a bank, investment bank, or broker 615 has a discussion with one or more lead underwriting managers 617. If the asset will be directly issued, discussions would include borrower(s), bond issuer(s), stock issuer(s), or other parties originating assets 607. Specifications such as size, maturity(ies) and servicers are determined at 609, and then an asset contract is created or modified 619 and any regulatory filings are printed or output electronically 621.

At 623 asset shares are issued and money moves from the underwriting managers to the issuer(s) or prior owners of the assets. Any applicable surety, bond guarantee, or credit enhancement fees can be paid at this point. Such fees might also be paid on an ongoing basis. At that point, asset shares 625 exist within the contracts exchange system. Assets might also have various tranches, options, and/or futures created 627. Such tranches, options, and/or futures 627 might be created at the same time as asset shares 625, might be created later, or might never be created at all.

Assets, and any options, futures or tranches, are traded at the exchange at 629. Each trade involves traders 635, and the contracts exchange or asset exchange 633. Any asset exchange in 633 is part of the contracts exchange system 100 mentioned in FIG. 1.

Any interest, principal, dividends, or other payments from the issuer(s), owner(s), or other obligor(s) 631 are paid to the contracts or asset exchange 633, and then allocated to traders 635 owning shares on the payment dates. Traders 635 might send part or all of the portion of interest, principal, dividends, or other payments from the issuer(s), owner(s), or other obligor(s) 631 which they receive to the traders' shareholders 637. Traders 635 might also retain such cashflows for their own operation.

As trading occurs 629, trading information is output in printed and/or electronic form 641. Such information might include prices, volume, times of transactions, or parties buying and selling.

Some assets have a contractually scheduled end, such as bonds reaching maturity. Others have no scheduled endpoint, such as shares of common stock. Common stock is sometimes repurchased, or exchanged for other shares or cash in a merger or acquisition. If some or all shares of an asset are retired, repurchased, or paid off at 643, the number of shares of the asset on the exchange decreases, or may even go to zero.

Some assets may exist in substantially the same form both within the contracts exchange system and elsewhere. These mirror assets might trade on an organized exchange, have a central clearinghouse, or be traded over the counter. Issuers might also issue additional shares over time, either on the contracts exchange system or elsewhere.

The preferred embodiment of the system is designed to allow the number of shares of an asset on the exchange to rise and fall by adding shares to existing contracts traded on the exchange, or reducing the share count 645. One example of adding shares is a bond which trades both on the contracts exchange system and the NYSE. Price differentials could arise due to any number of factors. For example, higher liquidity on the contracts exchange system could lead to higher prices for otherwise identical bonds vs the NYSE. In that case, additional bonds could be purchased on the NYSE and sold on the contracts exchange system. If such a differential persisted, more and more of that particular bond would trade on the contracts exchange system.

If more shares are desired on the exchange, 647 returns to 601. It is possible that something has changed from the original issuance, and an asset might not qualify to have additional shares added to the exchange. If so, the process would stop at 603 and no new shares would be added. Otherwise, the process continues from 605.

If fewer shares are desired on the exchange, 647 branches to 649, where shares are sold via the exchange to outsiders. This reduces the number of shares trading within the exchange and changes the number of shares under the asset contract 619. For example, if a bond is trading at a higher price outside of the exchange, one or more traders could offer to sell to outsiders via the exchange.

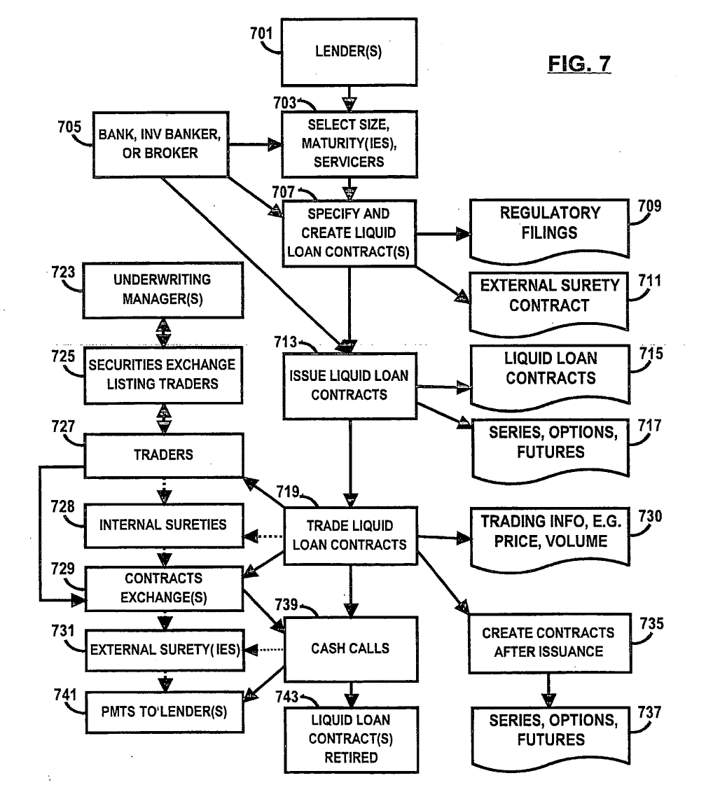

FIG. 7 is a diagram showing a preferred method 700 of how liquid loan contracts can be issued by a contracts exchange system.

Related application U.S. patent application Ser. No. 12/075,597 discloses liquid contracts. A special case of a liquid contract where a trader is obligated to make future payments is when the traders who hold shares are obligated to make precisely known future payments at precisely known future points in time. While the cashflows themselves are not risky, the market value of such a contract will still change over time. This type of contract can be referred to as a Fixed Rate Liquid Loan Contract. Liquid Loan Contracts could also use variations in payments which are currently used in other contexts, such as: variable interest rates, teaser rates, minimum and maximum rates of change, and balloon payments.

Note that the cash flows for liquid loan contracts from an external lender are reversed from assets which become traded on the contracts exchange system. Money initially flows from the lender into the contracts exchange system, and then interest and principal flow back out to the lender.

To an outside lender, the cashflows would resemble making loans to or buying bonds from creditworthy customers. Such loans or bonds would in some respects resemble municipal bonds with a bond guarantee from a third party (e.g., State of Washington bonds guaranteed by FSA), or a bank loan to a corporate client and a corresponding credit enhancement (e.g., Wells Fargo loan to Xerox and a credit enhancement on Xerox with HSBC as the counterparty).

A unique characteristic of lending in the form of a liquid loan is that the party(ies) ultimately obligated to pay the loan could change over time without notice or permission of the lender. The contracts exchange system makes this possible, since outside surety is provided to the lender, and internal policies and sureties provide assurance that payments under Liquid Loan Contracts will be made in a timely fashion. For an individual trader, the total cost of a Liquid Loan Contract includes the payment obligations and related surety cost. Therefore, a trader operating more conservatively would likely see a lower total cost of capital than a trader which is more highly levered or holds a more volatile portfolio. [note to Vic and Lee, this may be sufficiently unique to warrant a claim on moving credit around seamlessly between borrowers of different creditworthiness].

FIG. 7 illustrates exemplary steps for creating and trading one or more Liquid Loan Contracts which are traded on an exchange.

One or more lenders 701 select a loan size, one or more maturities, and servicers 703. A bank, investment bank, broker, or advisor may help in choosing said loan size, maturities, and servicers. Loan contracts are then specified and created 707. Liquid loan contract share sizes are determined at this point. For example, if the total size of the loan is $100 million in 703, there might be 100,000 shares with a face or notional value of $1000 each. Any regulatory filings are created 709, and an external surety contract may be issued to the lender 711. Said external surety contract might be from a third party provider (such as a bond guarantee firm or credit enhancement provider), or might be from the exchange itself.

Liquid loan contracts are issued 713, resulting in the contracts themselves 715, which will trade on the exchange, and series, futures, or options 717 might be created at the time of issuance. For example, the ability to borrow at certain points in the future might be important to certain traders. Such a trader could purchase an option for a designated number of shares of the liquid loan contract at a designated price and designated future date (European option), or anytime before a designated future date (American option).

The liquid loan contract has ongoing trading 719 between traders 727 on a contracts exchange 729, and trading information such as price, volume, and times of trades are collected 730. Each time a share of a liquid loan contract 715 changes hands, one or more internal sureties 728 is notified of the change. This may result in changes in surety fees to individual traders. In the case of multiple internal sureties on an exchange, trades of liquid loan contract shares may result in an individual surety covering more or less shares of the liquid loan contracts.

Traders 727 might have leverage, borrowing, or other constraints imposed upon them directly by a sureties exchange listing traders 725, or by the underwriting manager(s) 723 for the traders(s) 723.

Cash calls 739, such as principal and interest payments, are due from the contracts exchange 729 and paid to one or more lenders 741. Timely payment to the lender(s) may be guaranteed by one or more external sureties 731. The contracts exchange system or the contracts exchange itself 729, or a clearinghouse or designee, collects the payments on specified dates from traders 727 holding shares in the liquid loan contract. The contracts exchange might collect payments on the same date, or different dates, than payments are due from the contracts exchange to lenders. For example, if local regulation or bank arrangements required two business days to clear transactions, payments to lenders might be on the 10^{th} business day of the month, but payments from traders to the contracts exchange might be on the 7^{th} business day of the month.

If one or more traders 727 do not provide timely payment to the contracts exchange 729, one or more internal sureties 728 will provide such payment to the contracts exchange 729. Said internal surety 728 may then take actions to receive reimbursement from the one or more traders for whom it has advanced payment.

It is possible that new contracts related to liquid loan contracts 719 are created after issuance 735. If so, new series, options, or futures 737 commence trading.

While it is possible that some liquid loan contracts would be perpetual obligations with no expiration or maturity date, most liquid loan contracts will have an eventual expiration or maturity date. If set of liquid loan contracts was issued as a series, such maturities might be a different times. For example, a series might have some contracts which expire 6 months after issuance, and then at 18, 24, 30, and 36 months. When liquid loan contracts expire, mature, or otherwise have no remaining liabilities, they may be retired by the contracts exchange system.

It is possible that particular lenders might wish to have very similar loans and liquid loan contracts issued at different times. For example, a bank might wish to make an overlapping series of loans with 90 day maturities, with new loans created every 30 days. Over time, interest rates for similar loans would be expected to vary. Total loan amounts might also vary for similar issues in the series (e.g., $10 million issued in March, $11.2 million issued in April, $9.1 million issued in May).

### Method of Rating Issuers of Bonds

Up until the invention, the business of rating bonds is concentrated. Three large firms command large fees for rating issuers of bonds. Requirements for credit ratings such as A, AA or AAA are built into millions of contracts. A downgrade of an issuer may trigger a requirement for additional collateral or restrictions on amounts that can be lent. The fees are often substantial. The analysis and decision-making is often done confidentially rather than in the open marketplace of ideas. Perhaps most important, there is little or no evidence that the ratings provided by these firms have any predictive value.
“Mar. 20, 2009 (Wall Street Journal)—Credit-rating companies, widely assailed for their role in fueling the financial crisis with overly rosy debt ratings, stand to make a billion-dollar windfall in the government's latest attempt to heal the credit markets. The new rescue effort, run by the Federal Reserve, kicked off Thursday with bond deals totaling more than $7 billion. Each bond issue will need to be blessed by at least two of the three big rating firms: Moody's Investors Service, Standard & Poor's Ratings Services and Fitch Ratings. These firms dominate the credit-ratings business, and their imprimatur is considered crucial for investors that buy bonds and asset-backed securities. They have been vilified in recent months because their ratings on mortgage securities were widely off base.”

The contract exchange system can be adapted to provide ratings of bond-issuing firms. To do so, the exchange must have a sufficient credit standing that its own credit rating is high, such as AA; further, all contracts on the contracts exchange must have had their surety guarantee and the surety guarantee must be from a guarantor that itself has a surety guarantee; in this case the credit standing of each transparent trading firm is impeccable. The other methods of disclosure of credit costs shown in FIG. 2 also are used, including interconnected data exchange and reporting systems.

With the contract exchange system configured this way, rating an issuer of a bond can be done with the following steps:

The issuer prepares to issue the bond including preparing to place a part of the bond on the contracts exchange using the method of listing an asset described using FIG. 6 or, if appropriate, the more general description of listing a contract using FIG. 4.

The Underwriting Manager or managers 617 that serve as “leads” in pricing that kind of bond within the contracts exchange system 619 determine the price for initial offering of shares of the part of the bond traded on the contracts exchange

The initial share price 623, the price which the bond commands on the open market 641 and other data are reported on computer systems including a publicly accessible data base

The data are processed using an algorithm sufficient to prepare a rating of the issuer such as AAA, AA, etc.

The resulting rating of the bond issuer is communicated to the public on a data base or via electronic or other media.

Persons familiar with the business of rating of issuers of bonds will apply slightly different methods as their experience suggests. For example:

The final step of communication to the public might involve a meeting with the issuer of the bond to provide evidence of the rating and its reasons

The algorithm sufficient to prepare a rating may provide sensitivity testing to determine what the rating would have been if the data had been different than it was, including stress testing under a range of hypothetical adverse conditions

The rating of an issuer may be done using data about the bonds issued by the issuer in prior times. In particular, for an issuer that has shares of bond contracts trading on the exchange the algorithm may be run from time to time even if no new bond is being considered for funding by the contract exchange system.

Using a contract exchange system to provide ratings of issuers of bonds has several novel and advantageous differences over the prior art. These include without limitation:

New bond rating firms may be started up at a small cost to compete in this concentrated industry. Start-up costs would cover the development of the algorithm including debugging any communications routines, marketing and the like. Such firms may dramatically reduce the costs of ratings of issuers of bonds, provide greater transparency and provide more accurate and useful ratings of issuers of bonds.

Novel features of this method of rating bonds include:
1. Sensitivity testing and stress testing of a rating, including disclosure of the tests and their results
2. Reliance on a sufficiently large set of data and rules that it becomes difficult for an issuer to position itself to manipulate its rating
3. Up to date rating of an issuer, rather than episodic or occasional re-evaluation of the issuer
4. Detection of fraud, error and manipulation by the issuer 607, bank or broker 615 or underwriting manager 617 using methods like those shown in FIG. 5 to detect fraud, error and manipulation by a transparent trading firm or surety.
5. Reduction and possible elimination of the problem that some issuers are deemed “too big to fail” by the markets, thus commanding AAA ratings until failure becomes a visible possibility.

The following is a listing of contracts between various parties, accessible by members of the exchange via a computer system.

Illustrative list of contracts between various parties, accessible by members of the exchange via a computer system:

Contract that is traded on the Contracts Exchange
First party: Individual, government, corporation, association
Second party: a Transparent Trading Firm
Data fields: Obligation to first party, currency, bank, clearing house, broker, surety guarantor, list of possible cash flows, number of shares, part of series, other pricing information

Surety Guarantee
First party: Surety guarantor
Second party: Transparent Trading Firm
Beneficiaries: all traded contracts, or a designated set of them
Data fields: several terms describing the current premium rating formula, history of all premium payments to date; history of all changes to the premium rating formula; current estimate of the market value of all shares listed on the Contracts Exchange and all shares listed on the Securities Exchange

Underwriting Management
First party: Underwriting Manager
Second party: Transparent Trading Firm
Data fields: legal description of the Underwriting Manager; mission statement of the Transparent Trading Firm; fee or system of assessing fees from the Firm; clauses for amendment, dispute, legal authority

Listing of the Transparent Trading Firm for investors
First party: Securities Exchange within the Contracts Exchange System
Second party: Transparent Trading Firm
Data fields: Underwriting manager, date of inception, initial capital, mission statement, registration information, computer pointers to electronic data bases of the Firm; surety guarantor, bank, clearing house, checklist of rights vested in the Contracts Exchange System
Other contracts are obvious to persons who are familiar with the art of designing contracts and storing relevant clauses electronically

The following is a listing of potential outside service providers to the contracts exchange system: software, clearing, displays, printing, order flows.

Potential outside service providers to a contracts exchange system:
publishers
writers
software developers
information technology providers
universities and think tanks
database security firms
governmental agencies
futures exchanges (agriculture, energy, derivatives and options)
credit rating agencies
stock exchanges
banks
computer network maintenance
wireless telecommunications
fiber-optic communications channels
outsourcing of information technology (IT) personnel

The following is a listing of sources of fee income for a contracts exchange system. Examples include without limitation: insurance companies; reinsurance companies; other firms ceding risk into the exchange; traders; fees for permitting or accrediting new traders, fees for surety provided directly by the exchange, fees from third party surety guarantors; software providers; persons who access the databases maintained by the contracts exchange; securities exchanges; sale of seats on the exchange; contracts market makers and securities market makers.

### Potential Sources of Fee Income for a Contracts Exchange System—Illustrative Examples

Motivation to pay fee income

| | contracts that | operating | |
|---|---|---|---|
| Source of fee | hedge risks | income | speculation |
| corporations | x | | |
| individuals | x | | x |
| governments | x | | |
| pension plans | x | | |
| associations | x | | |
| insurance companies | x | | |
| reinsurance companies | x | | |
| benevolent funds | x | | |
| mutual funds | x | | |
| hedge funds | x | | |
| real estate investors | x | | x |
| trust funds | x | | x |
| stock brokers | | x | x |
| real estate brokers | | x | x |
| commodities brokers | | x | |
| insurance brokers | | x | |
| reinsurance intermediaries | | x | |
| banks | x | x | x |
| investment banks | x | x | x |
| colleges and universities | x | | |
| religious organizations | x | | |
| speculators | | | x |
| publishers | | x | |
| virtual systems | | x | |
| software developers | | x | |
| clearing house functions | x | x | |

The contracts exchange can act as a clearing house, or the exchange can have a financial interest in a clearing house that it contracts with, realizing the profits and losses of this business activity. Acting as a clearing house, it can charge a fee for its services. The contracts exchange can also contract with a third party clearing house(s) in which the contracts exchange has no interest. Fees can be assessed as often as practical, perhaps averaging (by way of example) thirty minutes from the report of the trade until the collection of the clearing fee.

The contracts exchange can require each trader to submit reports, including reports of its holdings, reports of its franchise value, reports demonstrating that its shares are listed on a securities exchange and/or are traded so as to be considered liquid investments, and reports on the terms of a surety guarantee that is beneficial to the contracts exchange, including the basis for the premium calculation for such guarantee. The exchange can earn a filing fee for such reports by traders or earn a fee for storing such reports in electronic form.

The contracts exchange can maintain lists of contracts and securities traded on other exchanges that it deems liquid; it can charge a fee for access to this list.

The contracts exchange can act as a principal or sales agent in providing software for traders and others to do business; it can charge a fee for use of such software.

The exchange can operate with settlements essentially continuously. This might be accomplished by contracts through a worldwide bank or network of banks sufficiently broad to permit clearing of payment transactions essentially continuously and essentially globally. The contracts exchange can be paid a fee by such bank or banks.

The exchange can monitor the prices charged by at least one surety guarantor. The monitoring cost can be passed on to at least one surety guarantor authorized by the contracts exchange as well as other parties, either in part, in whole, or with a mark-up. The exchange can charge for the service and/or for licensing the software. For some contracts or traders, it is possible that their will be only one surety provider. While it is theoretically possible that no one would want to provide new surety for a particular trader (e.g., that trader is in financial trouble), or for a particular contract (e.g., the perceived risk is very high), outstanding surety contracts could remain in place.

The exchange can act as a surety guarantor for one or more surety guarantors that guarantee the traders that trade on the contract exchange, realizing the profits and losses of this business activity. Acting as a surety guarantor, it can charge a fee or “premium” for its service explicitly. Such a surety premium can be calculated so as to reflect each change in the exposure of the surety guarantor. Such premiums can be assessed as often as practical, perhaps (by way of example) not less than once in 60 minutes. As a guarantor of guarantors, the exchange could have the power to replace guarantors whose financial condition deteriorates, or who fail to meet other standards (e.g., timely settlement or capitalization). The ability to replace a downgraded or poorly performing surety makes all surety contracts on the exchange more valuable and less risky. By way of example, in credit default swaps and other non-exchange-traded contracts, deterioration of a counterparty can result in posting collateral, or even terminating the contract.

The following is a listing of methods which a contracts exchange system can use to promote liquidity in the contracts it trades.

Optional methods of promoting liquidity within a Contracts Exchange System:

Execute every transaction on an electronic trading floor, i.e., computer software resident on computer hardware

Execute every clearing operation electronically, i.e., on computer software resident on computer hardware

Execute every call order, sell order, buy order and clearing operation in each cycle of the computer routine

Execute cycles of the computerized order, transactions and clearing functions as often as needed, e.g., one hundred times per second

Execute cycles of the computerized order, transactions and clearing functions globally, e.g., on multiple computers in an array in more than one part of the Earth

Execute cycles of the computerized order, transactions and clearing functions continuously, e.g.,

without ever closing the Contracts Exchange System

Execute cycles of the computerized order, transactions and clearing functions without ever declaring a “closing price” or “last transaction” that has any particular significance

Prices of transactions may be positive or negative or vary between positive and negative

Shares of traded contracts may be standardized and characterized by a list of practical contractual terms that reduces any uncertainty about the specification of the contract

Shares of traded contracts may be subject to calls, e.g. by the Contracts Exchange System or by a surety guarantor

Shares of traded contracts may be purely financial obligations without an implicit surety guarantee or service obligation, e.g., such roles may have been unbundled using the method of Ser. No. 09/971,492

Trading on the contracts exchange may be limited to Transparent Trading Firms

A Transparent Trading Firm may be required to list its shares on the Securities Exchange within the Contracts Exchange System

A Transparent Trading Firm may be required to limit its holdings to shares traded on the Contracts Exchange and shares traded on the Securities Exchange that are within the Contracts Exchange System

A Transparent Trading Firm may be prohibited from entering into any contracts that might create an asset other than shares on a Contracts Exchange or a Securities Exchange within the Contracts Exchange System

A Transparent Trading Firm may be prohibited from entering into any contracts that might impose a liability other than shares on a Contracts Exchange

A Transparent Trading Firm may be prohibited from entering into any contracts that might impose a liability other than shares on a Contracts Exchange

A Transparent Trading Firm may be prohibited from any activity that results in a liability under law, regulation or common law, e.g., it may be prohibited from hiring people or operating as a tax-paying entity

Management of the affairs of a Transparent Trading Firm may be contractually delegated to an Underwriting Manager

With respect to a given Transparent Trading Firm, an Underwriting Manager may be required to own a minimum fraction of the shares, e.g. 1% or 10%

With respect to a given Transparent Trading Firm, an Underwriting Manager may be required to limit its ownership to a maximum fraction of the shares, e.g. 1% or 10%

With respect to a given Underwriting Manager, a Transparent Trading Firm may be required to vest all control in the designated Underwriting Manager

Owners of a Transparent Trading Firm may have no rights of action, e.g., all such rights may reside among the Contracts Exchange System, Contracts Exchange, the contracts themselves, the Underwriting Manager, and surety guarantors; e.g., owning of a share of a Transparent Trading Firm may be like owning a simple promissory note

The Contracts Exchange System may have the right to wind up the affairs of a Transparent Trading Firm, e.g. to preserve the System's methods of promoting liquidity

The Contracts Exchange System may have the right to change the legal status of Transparent Trading Firms to preserve the System's methods of promoting liquidity

A Transparent Trading Firm may be required may not be required to report any shares they held in the past but do not hold at the current moment

Traders may not be required to have margin accounts or position limits

Transactions may not be limited by price change limits

Every transaction may be reported in real time

A Transparent Trading Firm may be required to maintain a performance guarantee

A Transparent Trading Firm may be prohibited from having off-balance sheet assets or obligations

A Transparent Trading Firm may be required to maintain in an electronic data base a bid for each share of each contract that it is allowed to bid on

A Transparent Trading Firm may be required to maintain in-force a surety guarantee, e.g. a performance bond or financial guarantee

A Transparent Trading Firm may be required to use as its surety guarantor a company on a designated list of one or more acceptable surety guarantors

A Transparent Trading Firm may be required to pay a price (premium rate) for its surety guarantee that is computed continuously using data about the Firm's holdings and bids, e.g., any increase in risk will increase the premium rate (analogous to pay-as-you-drive car insurance)

A Transparent Trading Firm may be required to sell an asset when directed to do so, e.g. by the Contracts Exchange, the Contracts Exchange System or the Firm's surety guarantor

A surety guarantor may be required to maintain in-force a surety guarantee, e.g., all guarantees may hang together to guarantee all Transparent Trading Firms

A Securities Exchange within the Contracts Exchange System may be required to limit its listings to the Transparent Trading Firms within the Contracts Exchange System

A Securities Exchange within the Contracts Exchange System may be permitted to list common stocks that are deemed to be liquid

A Securities Exchange within the Contracts Exchange System may be permitted to comprise the functions of an Asset Exchange

Bids may be undisclosed except to the bidder's surety guarantor

Bids may be undisclosed except to the Contracts Exchange

Every transaction may comprise a single share rather than a volume of shares

These actions involve business methods at least one of which is not a method used by futures exchanges today. They include without limitation:

The contracts exchange can monitor traders who are not permitted to trade on the exchange as well as those who are.

The contracts exchange can act as the surety guarantor for a listed trader.

The contracts exchange can monitor the sureties, including without limitation their terms and prices, and the surety's own surety guarantees.

The contracts exchange can maintain a list of acceptable sureties; it can publish standards for a surety to follow to become listed.

The contracts exchange can act as the surety guarantor for a surety guarantor that provides a surety guarantee to a listed trader.

The contracts exchange can control or arrange for market makers which would have authority and responsibility to promote liquidity, including, without limitation: rights to acquire all units of thinly traded contracts; rights to underwrite new issues of contracts; rights to assume risks of loss from traders.

The contracts exchange can require traders or their sureties to grant the contracts exchange certain rights (as, for example, the New York Stock Exchange has the right to de-list stocks that fall below a certain share price).

The contracts exchange can take similar actions to promote the liquidity of securities issued by its traders.

The following is a listing of many of the ways in which a contracts exchange system could derive revenue.

### Methods of Deriving Income for a Contracts Exchange System:

Transaction fees

Publishing or providing bid or ask prices

Publishing or price and volume information

Publishing surety fees

Publishing information on systemwide risk in the contracts exchange system

Surety fees

Fees for initiating new contracts

Fees for initiating new traders

Fees for initiating new assets

Fees for initiating new sureties

Monitoring or audit of trader positions

Monitoring or audit of trader market value

Monitoring or audit of surety fees

Monitoring of sureties' risk positions and solvency

Such methods include: the exchange can charge a fee for transactions executed by the exchange. For example, fees can be charged for posting asking prices and offering prices; for executing trades; for posting the record of the ask, offer or trade to a data base; for confirming that accounts have been settled; for clearing a trade that has been executed. Securities exchange is where shares of traders must be listed.

In addition to the practices of existing exchanges, the contracts exchange system has novel methods of business. These include without limitation the following:

The contracts exchange system can monitor the traders, including, without limitation, their transparency, liquidity, franchise value and counterparty risk, preferably continuously, preferably whether or not they are listed traders on the contracts exchange The cost of monitoring can be passed on to traders and others, either in part, in whole, or with a mark-up.

The exchange can act as a surety guarantor for a particular trader or for all the traders trading on the exchange, realizing the profits and losses of this business activity. Acting as a surety guarantor, it can charge a fee or “premium” for its service explicitly. Such a surety premium can be calculated so as to reflect each change in the exposure of the trader. Such premiums can be assessed as often as practical, perhaps (by way of example) each time a trader changes its portfolio but not less than once in 60 minutes. This is distinct from current practice in several ways. 1. On most futures exchanges, the exchange (or its clearing operation) is the counterparty to every transaction. Being the counterparty includes insulating buyers and sellers on an exchange from counterparty risk. Everyone sees the same counterparty risk: the exchange itself. The exchange attempts to limit its counterparty risk by an assortment of methods, including daily trading limits.

According to the preferred embodiment, Trader A might get its surety guarantee from someone besides the exchange, and Trader B might get its surety guarantee from the exchange itself. Trader C might get its surety guarantees from yet another surety. Traders can switch sureties, and monitor premium formulas for their portfolio. 2. Currently, existing commodities and futures exchanges set fees which stay unchanged for long periods of time. Those fees implicitly include surety. For example, the CME does not suddenly raise its fees in times of unusual volatility or asset price declines.

Operating as a Bank or Central Bank

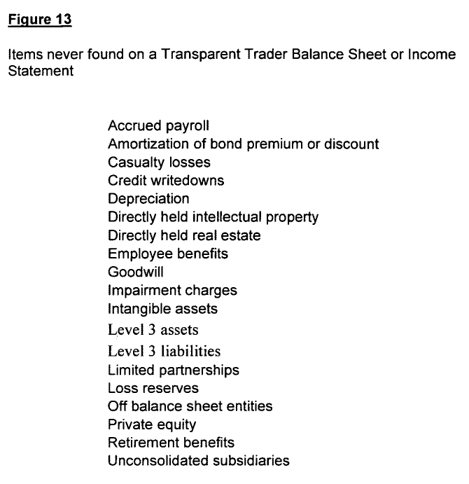

FIG. 13 illustrates a preferred contracts exchange system operating as a central bank. A system of trading contracts that are strictly assets as shown in FIG. 6 and trading liabilities that are strictly non-contingent loans as shown in FIG. 7 can be used as a bank or as a central bank. A bank is an entity that takes in deposits and makes loans. A central bank is a bank that takes in deposits from member banks and makes loans to member banks or a generalization of such a system. A central bank is a banker's bank. Like international air carriers, banks and central banks are often owned or supported by their governments.

Banks have widespread influence on social, economic and financial systems. Yet few people understand how banks interact or how a central bank operates in ways that affect the economy. See for example Brandeis, Louis, “Other People's Money and How the Bankers Use It,” published in 1914, which set the foundation for reform of banking laws during the Great Depression. The current system begs for change. For example, in his congressional testimony on Mar. 26, 2009, Treasury Secretary Timothy Geithner called for new regulation of banks and a new role for central banks.

The contract exchange system can be used as a central bank by operating as follows. One or more steps and/or features listed below may be omitted without impediment in certain embodiments of the use of the apparatus as a central bank. The phrase “member banks” in this specification may constitute one group of member banks for one step or embodiment and a different set of members for other steps or in ways of using the apparatus as a central bank. Persons familiar with banking will be able to apply their skills to modify the operation of a central bank to be that of a bank, in part by reintroducing some of the elements described in FIG. 1.
1. The traders may be transparent traders.
2. Because a central bank is a bank for banks to use, the seats on the securities exchange may be owned or otherwise controlled by the member banks.
3. The underwriting managers may be owned or otherwise controlled by the member banks. An underwriting manager may operate one or many transparent traders.
4. There may be a small number of traders in the apparatus or many.
5. The asset exchange and the loan exchange may be separate exchanges or combined.
6. Investors in a trader may be from the capital markets broadly but this is not necessary for a central bank; each trader may be owned by one or a few investors or by a single investor such as a member bank; the shares of a trader may not be actively traded; the contract exchange system may not have rights to take steps to maintain liquidity in the investments in a trader.
7. Surety functions may be carried out by the contract exchange system, by private parties, by government-sponsored authorities or by other means.

The capital markets may be able to inject capital to prevent a recession, or withdraw capital to prevent a credit bubble, without or in addition to any efforts by a government agency or authority; such activity may be more prompt, more accurate and more reflective of global conditions than in the prior art; in addition, such a capital movement may be modified, reduced or turned in direction entirely through the decisions of investors to buy or sell shares of traders.

A transparent trading firm has no employees or unpaid compensation to its underwriting manager so moral and political issues such as the AIG bonuses can not arise. (“Mar. 19, 2009 (Reuters)—President Barack Obama on Thursday welcomed a U.S. House of Representatives vote to tax bonuses to employees at companies getting federal bailout money, saying it “rightly reflects” outrage at hefty rewards paid by American International Group Inc.”)

Access to the capital markets directly or through the member banks as owners of the shares of a transparent trading firm is access to more wealth than a government alone has access to. (“Mar. 19, 2009 (Bloomberg)—Iceland's central bank lowered the benchmark interest rate by 1 percentage point and signaled more cuts are to come after the severest recession since World War II eased price gains. Policy makers lowered the repo rate to 17 percent from a record, the Reykjavik-based bank said in an announcement on its Web site. The rate cut is the first since the island came under International Monetary Fund administration in November.”)

Turning now to FIG. 13, customers including member banks 1301 deposit funds into the central bank contract exchange system 1300 as liquid loans as explained in FIG. 7. Customers might include entities such as banks, investment firms, the International Monetary Fund, the Bank for International Settlements, the Federal Reserve Board, other central banks. While it is possible that some entities might only deposit funds into the central bank contract exchange system, or only borrow from it, in the preferred embodiment, customers are permitted to both borrow and lend. In many instances, a particular customer might be a net lender at one point, a net borrower at another point in time, and have no lending or borrowing at some other times.

Member banks borrow funds from the contract exchange system by creating assets as explained in FIG. 6. In general the traders as a whole earn more on their loans than they pay for their deposits; in general this is a source of revenue to pay the operational expenses of the various parties and to provide a profit to the investors. In anticipation of such a profit the investors would buy the shares of a trader.

In the preferred embodiment, the parties inside of the dashed line are regulated and/or controlled by the contracts exchange system, or simply Apparatus, 1300: one or more exchanges listing assets 1305; one or more Liquid Contracts Exchange(s) 1307; one or more traders trading in contracts 1311; one or more internal sureties 1313, which provide assurance of timely payment to parties within the Contracts Exchange System, including traders 1311, contracts exchanges 1307, and contracts market makers 1315 through the clearing operation(s) 1322. Shares in traders 1311 are traded on one or more securities exchange(s) listing trader shares 1321, and there may be one or more trader shares market maker(s) 1317. Trader(s) trading contracts 1311 are managed and/or controlled by one or more underwriting managers 1327. One or more contracts market maker(s) 1315 and one or more trader shares market maker(s) 1317 may be traders 1311, the Contracts Exchange System itself, or special-purpose entities. Investors 1325 (which might include member banks) in trader(s) 1311, buy and sell shares of said trader(s) on one or more securities exchange(s) listing trader shares 1321. One or more clearing operations 1322 clear trades on liquid contracts exchange(s) 1307 and securities exchange(s) listing trader shares 1321. Potential clearing operations include, but are not limited to: third party firms, a direct subsidiary of an exchange, a sister company of an exchange, a partnership of more than one exchange. There may be holders of seats on one or more exchanges 1323. A seat might entitle a holder to trade on a liquid contracts exchange 1307, or a securities exchange 1321.

Operating as a bank or a central bank, the liquid loan contracts may be of limited variety and may be created without a broker. These liquid contracts may (as do time deposits in the prior art) show the currency, the maturity schedule, rights to early withdrawal if any and methods of computing interest. A simple example may be constructed by think of an “overnight repo” in the prior art: the contract would specify the bank account to which payment would be made, the amount to be paid, and the time of payment (e.g., to Bank of America US$100 million at 13:01 GMT; in this simple example, Bank of America might find that this contract is available for a deposit of US$99,997,654 at 02:00 GMT, eleven hours before maturity). Under the prior art, there is no exchange on which shares of such contracts can be traded, so each bank acts as a counterparty to another; with the contracts exchange system, the entire system acts as a counterparty to each depositor. Other differences from the prior art are enumerated below.

Operating as a bank or a central bank, the assets may be of limited variety and may be created without a broker. These liquid asset contracts may (as do interbank loans in the prior art) show the currency, the schedule of one or more payments of expenses, interest or principal, rights to amend the contract and methods of computing interest. A simple example may work like a bridge loan for working funds in the prior art: the asset contract would specify the bank account from which payments would be taken and the planned amount and time of each transfer of funds (e.g. from Bank of America US$1,500,000 at 13:01 GMT on the first of each month until and including December, 2010, and a final transfer of $300,000,000 at 13:01 GMT on Dec. 28, 2010, with a right to end the contract at any time before Nov. 28, 2010 by transferring US$301,000,000; in this simple example, Bank of America might find that with these terms it can borrow from the central bank $300,345,678 at 02:01 GMT on Jan. 3, 2009, two years before maturity. Under the prior art, there is no exchange on which shares of such contracts can be traded, so each bank acts as a counterparty to another; with the contracts exchange system, the entire system secures the interests of the investors 637.

A trader managed well might report an increasing book value per share or may pay a dividend to its investors. To the extent that shares of a trader may be bought or sold on the securities exchange, the trading prices may reflect the confidence that the investors have in a trader, an underwriting manager, a member bank or the central bank itself. To the extent that investments as a whole trade at higher than book value, the credit-worthiness of the system may be judged to be strong; to the extent that investments as a whole trade at or near or below book value, the credit-worthiness of the system may be judged to be weak.

As explained in the description of FIG. 2, computers accessing information from within and outside the contracts exchange system operating as a central bank may report through electronic, paper and other media about the credit-worthiness of the system and its components.

Persons with skill and art in banking will appreciate many other novel aspects of using a contracts exchange system as a bank or central bank.
There may be no collateral for loans.
If the traders are transparent traders, trading of the shares of the asset contracts and the liquid loan contracts provides price discovery through an active marketplace even when the deposits are left to maturity and the loans are never traded outside the bank or central bank.
Interbank deposits and interbank loans can be executed without seeking a counterparty because counterparty risk is minimized as described in U.S. patent application U.S. patent application Ser. No. 12/075,597

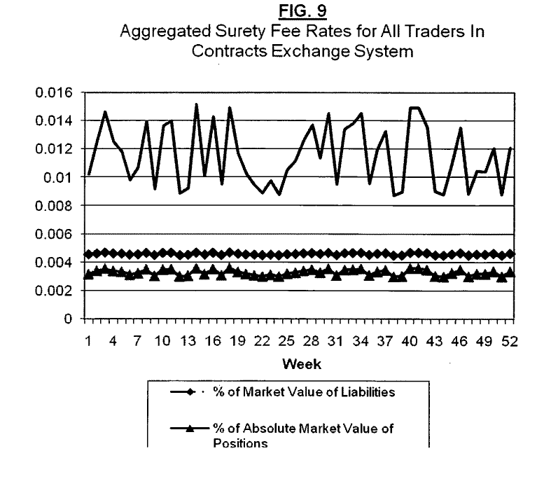

FIG. 9 is an exemplary display of aggregate surety fees over time in a contracts exchange system for the data shown in the following table. Fees are displayed as a percentage of: trader share market values; market value of total liabilities; and absolute market value of positions.

| | | | | | Surety Premiums as a % of | | |
|---|---|---|---|---|---|---|---|
| | | | | | | | Market |
| | Total Surety | | | | Market | Absolute | Value of |
| | Premiums | Market Value | Absolute Market | Market Value of | Value | Value of | Trader |
| Week | Charged | Liabilities | Value of Positions | Trader Equity | Liabilities | Positions | Equity |
| 1 | 4,583,131 | 1,000,000,000 | 1,404,727,081 | 416,868,894 | 0.46% | 0.33% | 1.10% |
| 2 | 4,516,731 | 1,004,205,134 | 1,493,811,289 | 504,294,340 | 0.45% | 0.30% | 0.90% |
| 3 | 4,694,549 | 1,004,007,196 | 1,320,014,030 | 325,487,039 | 0.47% | 0.36% | 1.44% |
| 4 | 4,675,809 | 1,013,232,132 | 1,392,214,142 | 390,351,470 | 0.46% | 0.34% | 1.20% |
| 5 | 4,638,309 | 1,013,591,966 | 1,430,728,978 | 429,651,123 | 0.46% | 0.32% | 1.08% |
| 6 | 4,596,104 | 1,011,325,190 | 1,458,434,295 | 460,522,378 | 0.45% | 0.32% | 1.00% |
| 7 | 4,562,555 | 1,011,375,423 | 1,491,299,579 | 494,321,880 | 0.45% | 0.31% | 0.92% |
| 8 | 4,669,086 | 1,007,432,627 | 1,364,788,969 | 368,077,032 | 0.46% | 0.34% | 1.27% |
| 9 | 4,549,155 | 1,006,924,790 | 1,478,253,581 | 485,468,655 | 0.45% | 0.31% | 0.94% |
| 10 | 4,690,878 | 1,007,129,043 | 1,341,854,910 | 344,767,644 | 0.47% | 0.35% | 1.36% |
| 11 | 4,557,762 | 1,006,768,717 | 1,468,983,658 | 476,081,389 | 0.45% | 0.31% | 0.96% |
| 12 | 4,561,997 | 1,009,860,251 | 1,482,970,728 | 487,303,791 | 0.45% | 0.31% | 0.94% |
| 13 | 4,542,059 | 1,004,022,719 | 1,468,153,390 | 478,054,591 | 0.45% | 0.31% | 0.95% |
| 14 | 4,641,114 | 999,570,612 | 1,345,918,930 | 356,738,767 | 0.46% | 0.34% | 1.30% |
| 15 | 4,712,939 | 1,010,167,474 | 1,338,223,677 | 337,897,889 | 0.47% | 0.35% | 1.39% |
| 16 | 4,686,630 | 1,005,221,143 | 1,334,809,216 | 339,475,714 | 0.47% | 0.35% | 1.38% |
| 17 | 4,597,388 | 1,010,402,208 | 1,451,783,975 | 454,623,220 | 0.46% | 0.32% | 1.01% |
| 18 | 4,711,700 | 1,018,481,228 | 1,388,098,785 | 380,706,083 | 0.46% | 0.34% | 1.24% |
| 19 | 4,657,835 | 1,023,463,718 | 1,469,564,018 | 459,483,309 | 0.46% | 0.32% | 1.01% |
| 20 | 4,628,163 | 1,031,675,670 | 1,546,447,784 | 530,215,277 | 0.45% | 0.30% | 0.87% |
| 21 | 4,796,441 | 1,030,475,160 | 1,376,043,260 | 355,935,143 | 0.47% | 0.35% | 1.35% |
| 22 | 4,787,337 | 1,027,180,446 | 1,365,592,871 | 348,564,798 | 0.47% | 0.35% | 1.37% |
| 23 | 4,628,705 | 1,026,479,951 | 1,515,504,442 | 503,695,226 | 0.45% | 0.31% | 0.92% |
| 24 | 4,821,407 | 1,035,937,998 | 1,383,785,658 | 358,283,089 | 0.47% | 0.35% | 1.35% |
| 25 | 4,702,628 | 1,042,947,243 | 1,540,139,643 | 512,108,172 | 0.45% | 0.31% | 0.92% |
| 26 | 4,695,516 | 1,038,267,500 | 1,519,647,594 | 495,821,497 | 0.45% | 0.31% | 0.95% |
| 27 | 4,835,634 | 1,037,695,053 | 1,380,259,499 | 352,841,379 | 0.47% | 0.35% | 1.37% |
| 28 | 4,809,773 | 1,038,127,647 | 1,407,899,280 | 380,864,782 | 0.46% | 0.34% | 1.26% |
| 29 | 4,745,450 | 1,040,106,222 | 1,481,932,986 | 455,081,567 | 0.46% | 0.32% | 1.04% |
| 30 | 4,718,905 | 1,050,143,551 | 1,566,467,090 | 531,813,245 | 0.45% | 0.30% | 0.89% |
| 31 | 4,935,284 | 1,057,407,908 | 1,398,918,303 | 351,755,706 | 0.47% | 0.35% | 1.40% |
| 32 | 4,941,240 | 1,064,776,893 | 1,436,276,243 | 382,644,331 | 0.46% | 0.34% | 1.29% |
| 33 | 4,898,713 | 1,065,126,875 | 1,479,613,673 | 426,921,402 | 0.46% | 0.33% | 1.15% |
| 34 | 4,896,250 | 1,076,010,087 | 1,545,719,347 | 483,800,539 | 0.46% | 0.32% | 1.01% |
| 35 | 4,990,330 | 1,084,440,005 | 1,503,731,554 | 431,870,295 | 0.46% | 0.33% | 1.16% |
| 36 | 5,004,501 | 1,089,295,620 | 1,518,399,385 | 441,976,878 | 0.46% | 0.33% | 1.13% |
| 37 | 5,088,334 | 1,086,695,877 | 1,421,788,291 | 345,145,186 | 0.47% | 0.36% | 1.47% |
| 38 | 4,898,939 | 1,088,741,195 | 1,617,640,930 | 544,766,728 | 0.45% | 0.30% | 0.90% |
| 39 | 5,057,249 | 1,092,979,809 | 1,488,756,213 | 407,649,696 | 0.46% | 0.34% | 1.24% |
| 40 | 4,919,544 | 1,092,548,264 | 1,619,924,785 | 543,197,817 | 0.45% | 0.30% | 0.91% |
| 41 | 4,963,187 | 1,094,367,334 | 1,588,202,060 | 508,649,767 | 0.45% | 0.31% | 0.98% |
| 42 | 4,917,494 | 1,091,401,309 | 1,615,199,592 | 539,512,231 | 0.45% | 0.30% | 0.91% |
| 43 | 4,978,028 | 1,090,073,380 | 1,548,654,683 | 472,338,742 | 0.46% | 0.32% | 1.05% |
| 44 | 5,088,936 | 1,094,000,028 | 1,463,965,639 | 381,064,579 | 0.47% | 0.35% | 1.34% |
| 45 | 5,077,401 | 1,097,969,273 | 1,498,402,022 | 412,445,731 | 0.46% | 0.34% | 1.23% |
| 46 | 5,042,693 | 1,101,041,356 | 1,550,084,242 | 462,514,172 | 0.46% | 0.33% | 1.09% |
| 47 | 5,010,638 | 1,109,052,671 | 1,628,106,725 | 534,625,675 | 0.45% | 0.31% | 0.94% |
| 48 | 5,174,254 | 1,113,972,859 | 1,498,060,126 | 395,609,886 | 0.46% | 0.35% | 1.31% |
| 49 | 5,216,984 | 1,113,691,175 | 1,454,926,295 | 351,472,174 | 0.47% | 0.36% | 1.48% |
| 50 | 5,159,944 | 1,121,791,236 | 1,557,725,017 | 449,011,795 | 0.46% | 0.33% | 1.15% |
| 51 | 5,102,690 | 1,130,298,536 | 1,663,116,770 | 548,802,781 | 0.45% | 0.31% | 0.93% |
| 52 | 5,151,795 | 1,126,788,804 | 1,594,894,797 | 482,149,172 | 0.46% | 0.32% | 1.07% |

Portfolio Management by a Transparent Trader

A transparent trader (and/or its manager) may use many well-known methods used by hedge funds and other portfolio managers, but it also has novel methods of doing business. As more fully described in the U.S. patent application Ser. No. 12/075,597, a transparent trader is a trading fund that holds essentially all liquid exchange-traded assets and/or liabilities.

In a preferred embodiment, the transparent trader preferably has little or no assets or liabilities other than those traded on the contracts exchange system of patent application U.S. patent application Ser. No. 12/075,597. Specifically, the transparent trader preferably has no obligations for payroll, taxes, rent, or other expenses, which, taken together, imply that operation of the transparent trader is a function of a third party under contract, herein called the underwriting manager. A transparent trader can hold a portfolio that includes exchange-traded assets and does not include any liabilities. Such a trader could resemble some existing closed end funds. However, there are important differences. The following disclosure from a 2008 annual report of a closed end fund is typical:
“The Fund has procedures to determine the fair value of individual securities and other assets for which market prices are not readily available or which may not be reliably priced. Methods for valuing these securities may include: fundamental analysis, matrix pricing, discounts from market prices of similar securities, or discounts applied due to the nature and duration of restrictions on the disposition of the securities. Due to the inherent uncertainty of valuations of such securities, the fair values may differ significantly from the values that would have been used had a ready market for such investments existed.” Templeton Emerging Markets Income Fund 2008 annual report, page 21.

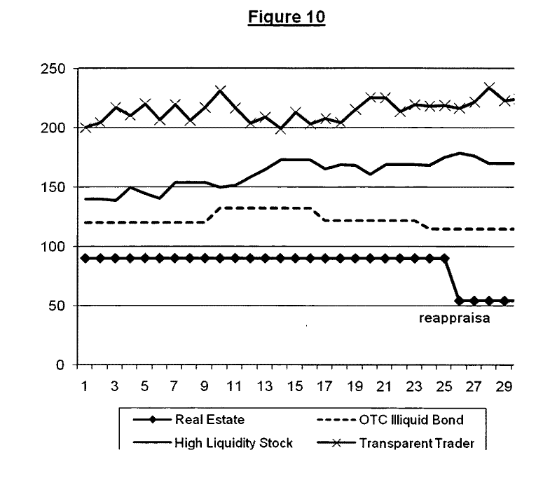

FIG. 10 is a chart illustrating the book valuations for three assets which might be carried on a closed end fund's balance sheet over a single month as shown in the following table. In this example, a real estate investment in an office tower has been revalued 40% less upon reappraisal. Since the market for real estate is not standardized and individual properties are not exchange traded, estimates are imprecise, even at the moment they are released.

Current state of the art closed end fund

| | | OTC | | | | | |
|---|---|---|---|---|---|---|---|
| | Real | Illiquid | Common | | | | |
| | Estate | bond | Stock | | | | |
| 1 | 100 | 200 | 300 | 90 | 120 | 140 | 200 |
| 2 | 100 | 200 | 300 | 90 | 120 | 140 | 204 |
| 3 | 100 | 200 | 297 | 90 | 120 | 138.6 | 217 |
| 4 | 100 | 200 | 321 | 90 | 120 | 149.8 | 210 |
| 5 | 100 | 200 | 310 | 90 | 120 | 144.66667 | 220 |
| 6 | 100 | 200 | 301 | 90 | 120 | 140.46667 | 207 |
| 7 | 100 | 200 | 330 | 90 | 120 | 154 | 220 |
| 8 | 100 | 200 | 330 | 90 | 120 | 154 | 206 |
| 9 | 100 | 200 | 330 | 90 | 120 | 154 | 217 |
| 10 | 100 | 220 | 321 | 90 | 132 | 149.8 | 231 |
| 11 | 100 | 220 | 326 | 90 | 132 | 151.59952 | 216 |
| 12 | 100 | 220 | 339 | 90 | 132 | 158.17097 | 204 |
| 13 | 100 | 220 | 344 | 90 | 132 | 164.88195 | 209 |
| 14 | 100 | 220 | 364 | 90 | 132 | 172.84086 | 199 |
| 15 | 100 | 220 | 364 | 90 | 132 | 172.84086 | 213 |
| 16 | 100 | 220 | 364 | 90 | 132 | 172.84086 | 203 |
| 17 | 100 | 203 | 353 | 90 | 121.8 | 165.5257 | 208 |
| 18 | 100 | 203 | 354 | 90 | 121.8 | 168.9041 | 204 |
| 19 | 100 | 203 | 363 | 90 | 121.8 | 168.2415 | 215 |
| 20 | 100 | 203 | 355 | 90 | 121.8 | 160.83381 | 226 |
| 21 | 100 | 203 | 352 | 90 | 121.8 | 168.6848 | 225 |
| 22 | 100 | 203 | 352 | 90 | 121.8 | 168.6848 | 214 |
| 23 | 100 | 203 | 352 | 90 | 121.8 | 168.6848 | 219 |
| 24 | 100 | 191 | 360 | 90 | 114.6 | 168.57024 | 218 |
| 25 | 100 | 191 | 375 | 90 | 114.6 | 175.41524 | 219 |
| 26 | 60 | 191 | 383 | 54 | 114.6 | 178.84161 | 216 |
| 27 | 60 | 191 | 383 | 54 | 114.6 | 176.65973 | 222 |
| 28 | 60 | 191 | 367 | 54 | 114.6 | 169.87489 | 234 |
| 29 | 60 | 191 | 367 | 54 | 114.6 | 169.87489 | 223 |
| 30 | 60 | 191 | 367 | 54 | 114.6 | 169.87489 | 224 |

The situation is slightly better for a thinly traded bond on the OTC market. At least there are occasional trades of exactly the same security which the fund holds.

For the widely held and frequently traded stock which the fund owns, there are trades averaging every few minutes that the exchange is open. However, on weekends there is no new trade data. Thus, there are “flat spots” on the market valuation of this stock.

In contrast, for a transparent trader, such sources of difficulty in valuing its portfolio are eliminated or greatly reduced. As described in application yyyy (02) by the current inventor, all of the assets and liabilities traded on the contracts exchange system can be traded continuously 24 hours a day seven days a week. Rather than displayed end of trading day values, a chart similar to FIG. 15 for a transparent trader could show variation much more frequently. The exchange will have various methods of increasing liquidity and modifying or retiring contracts which are no longer liquid. perhaps these paragraphs are not adding anything new over the 02 specification

Although the transparent trader that holds only exchange-traded assets has available the opportunities that are available to an “exchange-traded fund” or other fund of securities that is listed on a securities exchange today, it also has several new methods of managing its portfolio. The transparent trader pays for a surety guarantee from a surety guarantor; this surety guarantor charges a premium that reflects the surety guarantor's assessment of the risk of default or inability to perform by the transparent trader. The benefit of operating with a surety guarantee changes the risk of default and so can be considered along with the benefits of other risk-management methods in managing the asset portfolio. The cost of this surety guarantee can be considered along with others costs in developing modifications of traditional methods of managing the asset portfolio. Better ways of reflecting the cost of the surety guarantee can lead to greater success. In addition, the transparent trader has access to information about other transparent traders, including their holdings, the history of their holdings, their current market price per share or unit, and the history of their share prices. Moreover, the transparent trader has access to information about the nature and premium formulas of at least one surety guarantor. This information can be included in the development of modifications of traditional methods of managing the asset portfolio.

A transparent trader will typically hold a portfolio that includes both exchange-traded contracts some of whose values are currently positive, and some of whose values are currently negative. For example, at a given time a transparent trader might hold securities with $50 billion of positive value and $40 billion of securities with a negative value, which is a “book value” of $10 billion. Such a portfolio is called “leveraged” or “geared”; in this example, the gearing ratio is five to one (or 5:1). The total value of the securities will vary from moment to moment. Although the transparent trader can achieve some degree of hedging, in the typical portfolio the book value will be more volatile than the total of the liabilities. Another way of saying this is that the gearing ratio of the typical transparent trader will be more volatile than the total asset value alone. Because of this leverage and this volatility, the transparent trader can use new methods to manage the portfolio, as discussed herein.

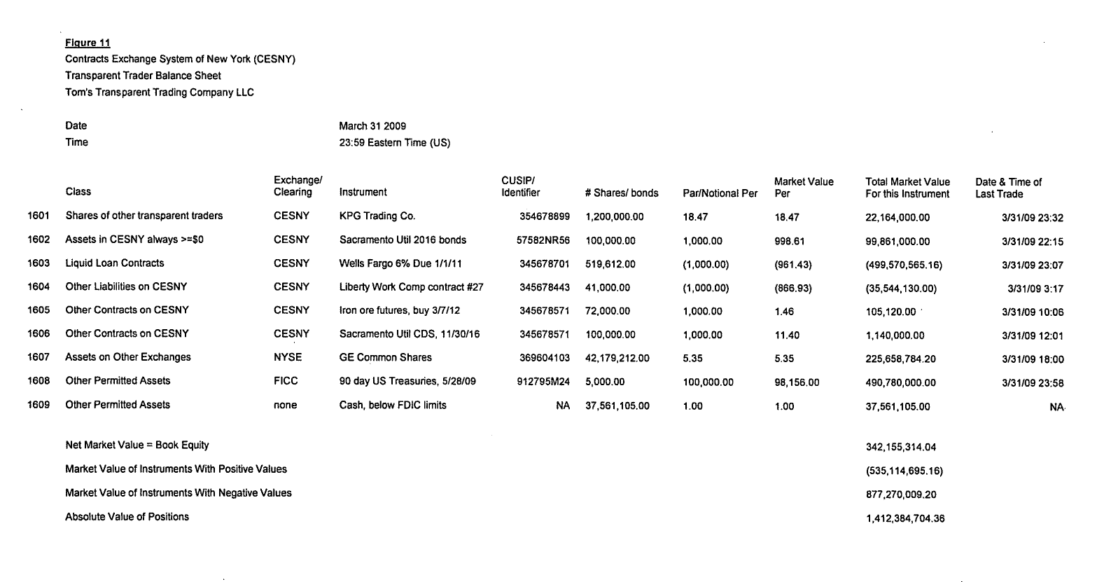

FIG. 11 is an exemplary display of assets, liabilities, and other commitments of a transparent trader. It constitutes an example balance sheet for a transparent trader. In the interest of brevity, a smaller number of positions are shown for this trader than would likely occur in practice. Where a single position in a particular class is shown in FIG. 16, in practice a transparent trader may have large numbers of positions in different securities, contracts, maturities, etc.

1601 is an example of shares in another trader. Shares of other transparent traders have values cannot drop below zero.

Other assets traded on the contracts exchange system whose values cannot drop below zero 1602. Sacramento Municipal Utility District bonds 1602, is an example of such an asset. A credit default swap on Sacramento Municipal Utility District bonds 1606, is another example.

Shares of money lent by Wells Fargo into the contracts exchange in the form of loan contracts 1603, is an example. Liquid loan contracts traded on the contracts exchange system (a particular form of liquid contracts) have values cannot rise above zero.

Other liabilities traded on the contracts exchange system (whose values cannot rise above zero). Workers compensation liability contract shares for a particular group of policies ceded from Liberty Mutual into the exchange 1604, is an example.

Futures, and other contracts on the contracts exchange system might have either positive, negative, or zero values in the future. Iron ore futures 1605, is an example.

Assets traded on other security exchanges (values cannot drop below zero). Exxon Mobil common shares traded on the New York Stock Exchange 1607, is an example. A contracts exchange system might, or might not, permit transparent traders to hold assets which are not traded on the contracts exchange system.

Other assets which the contracts exchange permits traders to hold. A contracts exchange system might have a list of assets which are permitted. US Treasuries 1608, are an example of an asset which might be permitted though it is not currently traded on an exchange. US

U.S. Treasuries have such a high transaction volume, deep market, well-organized clearing operations, and quick reporting that might securities could be permitted for transparent traders, despite not be traded on an exchange. Other potential examples of this category include cash 1609, and certificates of deposit.

Alternate Permitted and/or Prohibited Instruments

It is possible to have a transparent trader which only holds shares of other transparent traders. In this respect, it could function more like a mutual fund or a closed end fund. Such a trader would not hold any of items 1602-1608 in FIG. 16. Such a trader might specialize in holding shares of other traders of particular types, for example: traders in a particular market segment (e.g., workers compensation, currency); traders of a particular size range; or traders with offsetting or uncorrelated risk exposures. Much of the same technology used to choose investments for existing closed end funds, mutual funds, and exchange-traded tracking funds would be available to a trader which invests only in other transparent traders. Advantages to an investor in transparent traders include: high quality entries on the balance sheets and income statements of transparent traders; ease of comparison of the book value of a transparent trader with its current share price; and high liquidity of transparent trader shares. Transparent traders who only invest in other transparent traders might not be required to have any surety arrangements.

Another special form of a transparent trader is an asset only trader. Such a trader might exist to access unique securities on a contracts exchange. In addition to shares of transparent traders, it could hold any instrument or security traded on a contracts exchange system (or permitted by a contracts exchange) where the value of said instrument or security could not go below zero. An asset only trader's holdings might include: transparent trader shares, bonds traded on the exchange, common stock traded on the exchange, option contracts, REITs, or mutual fund shares. Such a trader would not require surety. Thus, an asset only trader might hold items 1601, 1602, 1607, and 1608. An asset only trader might also be allowed to purchase options or credit default swaps, but not be allowed to sell them.

A contracts exchange system might require that all assets, liabilities, and other commitments of a transparent trader are on traded on the contracts exchange system itself. In that case, a trader could not hold assets such as items 1607 and 1608 of FIG. 16.

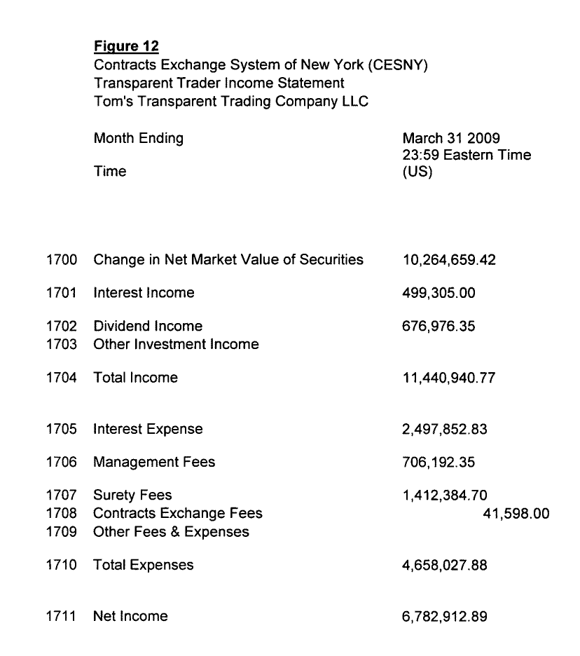

FIG. 12 is an exemplary income statement for a transparent trader. Transparent traders are notable for what items are not on their balance sheets or income statements.

FIG. 13 includes a listing of some items which would never be found on a transparent trader's balance sheet or income statement. Their existence would show that a trader has some asset and/or liability which is not liquid or does not have a clear market value which is updated frequently.

Examples of items not found on a transparent trader's income statement or balance sheet include: accrued payroll (transparent traders have no employees, but rather contract for such services); amortization of bond premium or discount; casualty losses; credit writedowns; depreciation (transparent traders do not hold real property or other real assets directly); directly held intellectual property; directly held real estate; employee benefits; goodwill; impairment charges intangible assets; level 3 assets; level 3 liabilities; limited partnerships; loss reserves; off balance sheet entities; private equity; retirement benefits; and unconsolidated subsidiaries.

A transparent trader can trade on more than one contracts exchange. Preferably, the transparent trader will trade on contracts exchanges that in the aggregate provide the ability to trade contracts continuously and world-wide.

Preferably, the shares of the transparent trader are being traded someplace in the world at all times. If a transparent trader is organized as a limited-liability entity, the trader may be listed on one or more securities exchanges. If a transparent trader is organized using a form that may create a liability on the part of investors, the trader may be a member on one or more than one contracts exchange. This form can be used to create intermediary entities whose management methods reflect some of the qualities of assets and some of the qualities of liabilities.

Preferably, a transparent trader would not trade on a futures exchange that requires a margin account, because a margin account is not a liquid asset. Nonetheless, a transparent trader can underwrite some of the risks that are traded on a futures exchange by investing in a trader in commodities or options on a traditional futures exchange if that trader is organized as a stock corporation or other limited liability form of organization and its shares are listed and actively traded on at least one securities exchange. A management company under contract to manage a transparent trader could also be under contract to manage such a futures trader. That is, one management company can be operating an active trader on a traditional futures exchange and operating a transparent trader. This generalizes the methods of operating a transparent trader to methods of operating a management company for a transparent trader.

A transparent trader can marginalize its default risk by obtaining surety or another form of financial guarantee. Alternatively, a transparent trader can marginalize its risk of non-performance by obtaining a performance bond; in particular, the transparent trader can maintain a contract that requires the surety to perform in the place of the transparent trader if the trader is unable to perform its contractual obligations. Financial guarantees and performance bonds are two kinds of surety guarantee. New kinds of surety guarantees may be created for transparent traders when the first transparent traders have been created. The cost of the surety guarantee will reflect the surety's perception of the risk of default or non-performance. If the surety guarantees are packaged as liabilities on a contracts exchange and traded actively, the prices of those packages of surety guarantees might reflect all information available to the capital markets.

A transparent trader can exert control over the costs of its surety guarantee by knowing the basis for the premiums it pays (as a manufacturer today knows the exposure basis of its liability insurance premiums) and reflecting those premiums in its strategic and tactical plans. For example (this is merely an illustration of what might be a complicated analysis), a transparent trader (call it “A”) might observe that its surety premium would cost only a small amount more if it increased its gearing ratio from 2:1 to 5:2, and then choose to underwrite more liabilities. Another transparent trader, “B”, with a more volatile portfolio than “A” might observe that its surety premium would cost significantly more if it increased its gearing from 2:1 to 5:2, and then choose not to underwrite more liabilities.

Transparent traders might issue new shares, retire existing shares, buyback shares, or hold treasury stock, or have standby stock purchase agreements. These techniques are well known to those skilled in corporate financial management.

There are at least two major reasons why traders might want additional capital. 1. A trader which was being managed well had a truly unlucky set of losses which investors think is unlikely to repeat. In that case, additional capital allows the trader to continue doing business. 2. A trader might be doing very well in its core business, but finds it is unable to expand quickly enough on internally generated profits. An example might be a successful auto insurance underwriter that currently underwrites risk in Maine, who sees that auto risk for New York and New Jersey will soon be added to the exchange. If the amount of auto risk on the exchange is about to increase by a factor of 20, it would take many years for a profitable trader to expand to 20 times its size on internally generated profits.

A transparent trader can demonstrate financial integrity by making its balance sheet transparent and its holdings liquid, then reducing its leverage. This sends a signal, “I'm stronger than 1 was a moment ago.” There are at least two ways of reducing gearing. One is to sell assets and liquidate liabilities without significantly changing cash on hand or net worth; as we have seen a transparent trader's book value of assets equals the market value of those assets, and the book value of its liabilities equals the market value of those liabilities. Thus the act of selling or liquidating itself never triggers a booked gain or loss. The other method is to raise more investment (net worth); traders who have experienced what the capital markets consider bad luck will be able to do so because their investors always knew the risks that were held in the trader's portfolio.

### HYPOTHETICAL EXAMPLE

### Earthquake

As a hypothetical example of a rapid price change for a liability, consider one share out of 10,000,000 outstanding shares of the exposure of the California Earthquake Authority (CEA). A total loss might be $140 billion, or $14,000 per share. On a given day, shares might be trading at $100. News of a major earthquake might increase the share price to $14,000 in as little as one minute. However, few earthquakes of the size that arise once in every 5 years will lead to financially significant losses to the CEA, and most earthquakes of the size that arise once in every 50 years will lead to a significant loss but not total loss. In this hypothetical example, as the first reports of the earthquake are made on seismographs, transparent traders holding the 10,000,000 shares issue automated orders to lay off the shares “at the market price”, creating 10,000,000 “offers” to pay the new market price; these offers might be matched by orders by the transparent traders to sell a list of assets (at the assets' market prices) in order to reduce the gearing of those transparent traders' remaining net worth. Those 10,000,000 offers can then be evaluated by automatic agents at other transparent traders to determine a response; each of these other traders can choose among an automated response, a response by a human or no response. In this hypothetical example, the responses vary in size from 10,000 shares to 10 shares; because of the flood of shares offered, each of these offers is accepted in sequence for a period of time (on the order of twenty seconds, in this hypothetical example), after which the asking prices of the responses begin to reflect that short history of trades as well as news from scientific sources and news on the radio, television, Internet and news services. Transparent traders that have taken on shares in these first few seconds may place offers to limit their losses. Continuing this example, as the clock ticks from twenty seconds to twenty-five seconds, the reports of damage and the trading prices of the shares act to drive up the asking prices from (say) $5,000 per share to $6,000 per share, which triggers new offers to pay the market price to lay off the liability of each of 100 shares now owned by a transparent trader which had received $5,000 a share just five seconds before. In addition, those transparent traders that created the secondary market might sell their own shares to obtain capital to reduce their gearing ratios in order to be prepared to underwrite the (now) high-risk CEA shares. By this mechanism, transparent traders that created the primary market for the shares exit the market, to be replaced by others who provide a secondary market using capital raised before and after the earthquake; those others are replaced by a tertiary market using capital raised before and after the earthquake expressly for the purpose of making a profit from the stress placed on the secondary market in the event that the secondary market traders decided to exit the market.
The news of the earthquake might cause the typical share to change hands three times in that minute, disbursing the risk of loss and the opportunity for profit by a factor of ten or more. The world's capital markets comprise $140 trillion of assets. By the end of the minute, the portfolios of dozens of traders and tens of thousands of investors have been rearranged by millions of transactions; in total the capital markets are poorer by some fraction of $140 billion, or less than 0.1%, which has been disbursed by the exchanges without the insolvency of any transparent trader.

This hypothetical example can help us to understand many of the methods the transparent trader can use to manage its portfolio.

The transparent trader can choose one or more niches in which to create a primary market. Transparent traders which create a primary market for shares of liabilities are paid for taking on the first issue of the shares of a given liability. In the example, several companies were paid $1 billion for the initial underwriting of the CEA shares (10,000,000 shares at $100 each). Over the long run, the primary market traders will realize a profit that is reflected in the equilibrium of supply and demand for their services and hence reflects the aversion to risk of the capital markets as well as the aversion to risk of the owners of property in California. All else equal, the more risk-averse everyone is, the more property owners will pay for earthquake coverage, the more the primary market will charge for the CEA shares, and the more the profit margin per dollar of share price of the transparent traders. That higher profit margin is the incentive that causes the capital markets to invest in the shares of the transparent traders.

The transparent trader can choose one or more niches in which to create a secondary market. This is not to say that there is a sharp line between the primary market and the secondary market, but that there is a difference in the style of operation. Transparent traders which create a secondary market can use a number of methods to maintain liquidity. For example and without limitation: 1) They can keep their gearing ratios down. 2) They can maintain portfolios of assets and liabilities that have less-than-average volatility. 3) They can aggressively manage their own share prices by trading their shares often to establish a track record of liquidity. Each of these methods reduces the gain on a typical day but positions the transparent trader in the secondary market to assume highly volatile positions with correspondingly high profit expectations when the primary market players have exhausted their capacity.

Certain LCs could be created which have completely known future cashflows. Such LCs could be traded among traders on the exchange. To an outside lender, the cashflows would have much in common with loans or bonds for creditworthy customers. Such loans or bonds would in some respects resemble municipal bonds with a bond guarantee from a third party firm (e.g., State of Washington bonds guaranteed by FSA), or a bank loan to a corporate client and a corresponding credit default swap (e.g., Wells Fargo loan to Xerox and a credit default swap on Xerox with HSBC as the counterparty). A unique charateristic of lending in the form of an LIC is that the party(ies) ultimately obligated to pay the loan could change over time without notice or permission of the lender.

The transparent trader can choose one or more niches in which to create a market of last resort. Again, this is not to say that there is a sharp line between a secondary or tertiary market and a market of last resort, but that the style of operation is at the edge of normal risk-averse behavior. Transparent traders which create a market of last resort will have conservative income statements and balance sheets most of the time, marked by unusual periods of high volatility. Managers who are positioning their portfolios to create markets of last resort can communicate their intentions to the investment community in order to nurture a respect for their strategy, but ultimately their strategy can include investing in conservative, liquid assets and liabilities during intervals between market dislocations.

The methods just described for traders that create primary markets, secondary markets and markets of last resort have their parallels in the world of exchange-traded assets. Although individuals and fund managers have played these roles in the capital markets since the creation of the first securities exchanges, when these roles are played by transparent traders the methods are changed. For example and without limitation, a transparent trader that chooses to be a creator of a market of last resort for a class of securities (such as shares of Countrywide Financial in August, 2007) can cultivate skill in underwriting liabilities of relatively low volatility in a diversity of industries and currencies so as to be able to raise cash quickly by underwriting liabilities in order to invest that cash in the targeted securities.

A special case of a contracts exchange system which affects transparent traders is an exchange which only handles loans, such as interbank loans.

### Liquidity

To liquidate an asset is to sell it for cash. To liquidate a liability is to transfer it to a third party, which usually requires the payment of cash. Liquidity is a quality of an asset or liability that it can be readily liquidated at a price determined by an active market. The transparent trader can take steps to reduce the incidence of holdings being rated as illiquid and promote the incidence of holdings being valued using Level 1 of FAS 157, as follows.

Assets: The transparent trader can take steps to reduce the frequency or cost of assets becoming less liquid. A general strategy is that the transparent trader can auction a portion of its shares of that asset as often as necessary to establish an active market. At the extreme, this strategy might lead to the sale of all of the problem shares.

Liabilities: The transparent trader can take steps to reduce the frequency or cost of liabilities becoming less liquid. A general strategy is that the transparent trader can auction a portion of its shares of that liability as often as necessary to establish an active market. At the extreme, this strategy might lead to laying off all of the problem shares.

### Contractual Obligations

A transparent trader can enter into contracts. For example, the trader might have contracts with a surety guarantor, several contracts exchanges, several securities exchanges, a world-wide bank and a management company. Preferably, these contracts are arranged so as to marginalize or reduce to insignificance any financial assets or liabilities under the contracts. Such financial constraints do not imply, however, that these contracts are insignificant to the operation of the transparent trader.

The transparent trader can grant to its surety guarantor various rights such as without limitation: a right to acquire illiquid assets from the trader at a discount from the last market price; a right to assume illiquid liabilities from the trader at a multiple of the last market price; or a right to place an order on behalf of the trader to liquidate a position. Such rights preferably arise when certain situations arise that are defined in the contract. Preferably the size of any discount or multiple is specified in the contract. Granting rights to the surety guarantor can be used to reduce the cost of the surety guarantee, either directly (e.g., by the premium rating mechanism of the surety) or indirectly (e.g., by stimulating a competitive market for surety guarantees).

The transparent trader can obtain from its surety guarantor various rights such as without limitation: a right to sell to the guarantor certain illiquid assets at a discount from the last market price; a right to lay off on the guarantor certain illiquid liabilities at a multiple of the last market price. Obtaining rights from the surety guarantor can be used to promote the liquidity of the holdings of the transparent trader and for other business purposes.

The transparent trader can grant to a contracts exchange on which it is permitted to trade various rights such as without limitation: for the exchange to authorize a market of last resort to assume all shares of a contract that is deemed to be illiquid at a multiple of the last market price; for the exchange to authorize a market maker to assume all shares of a contract that is deemed to be liquid but whose share price is low at the last market price or a multiple of the last market price; for the exchange to place on behalf of the trader an order to liquidate a position; to place an order on behalf of the trader to sell shares of the trader to the capital markets (e.g., to use that mechanism to lower the gearing ratio).

The transparent trader can grant to a securities exchange on which it is permitted to trade various rights such as without limitation: to authorize a market of last resort to assume all shares of a contract that is deemed to be illiquid at a discount from the last market price.

The transparent trader can grant to a securities exchange on which it is listed various rights such as without limitation: to de-list the transparent trader from the securities exchange if its share price falls too low or trading becomes too thin.

Because of such contractual rights and obligations, the transparent trader can negotiate with these parties before the contractual triggers are met and in other ways adjust its day-to-day tactics to reduce the frequency or impact of the exercise of such contractual rights and obligations. For example and without limitation, the transparent trader can ask its surety to make a market for a certain set of liabilities when trading becomes thin in that set of liabilities by offering to underwrite those liabilities at a price higher than the existing market price but less than the price it will receive if the contractual triggers are fired; the surety's offers result in trades which help to confirm that the market is active.

Persons familiar with the art will be able to adopt methods that have been used in the financial services industry. Here are examples of ways that management of securities portfolios and futures traders vary today:

### Structure and Legal Form:

contract
partnership
corporation
hedge fund
private equity fund
closed-end unit trust
mutual fund
exchange-traded fund
qualified defined benefit pension trust
endowment
foundation

### Domicile:

domiciled in a US state or territory
domiciled in a member of the EU
domiciled in a country other than the US or the EU
domiciled in a tax haven

| Expertise: | Examples: |
|---|---|
| in a particular industry | oil exploration; farming |
| in a rating tranche | Berkshire-Hathaway as insurer of last |
| | resort |
| hedging across currencies | |
| hedging over months or years | options traders |
| personal knowledge | General Electric |
| quantitative models | S&P Index Fund |

| Styles: | Examples: |
|---|---|
| subsidiary of a larger business | |
| aggregate of various businesses | General Electric |
| designed to be a hedge for a specific contingency | currency swaps |
| designed to be an index of a specific mix of contracts | WSJ “Prime rate” |

The transparent trader can pay a premium for a surety guarantee that is a function of the activity of the portfolio.
The transparent trader can draw on world-wide communications and analytical power. The high degree of liquidity that the transparent trader values may reflect the computational power of the computer and global communications, as well as their declining per-unit cost.
Until a sufficiently high degree of liquidity is achieved, traditional methods to cope with counterparty risk may be used, including collateral, margin accounts and daily price change limits.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in the above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the invention.

1. A contracts exchange system, comprising:
a liquid contracts exchange;
a trader trading on the liquid contracts exchange;
a securities exchange listing shares of the trader; and
a surety guaranteeing obligations of the trader.

2. The system of claim 1, further comprising:
software which verifies that holdings according to records of the trader, the surety, and the liquid contracts exchange all substantially match.

3. The contracts exchange system of 1, wherein the contracts exchange system comprises a central bank.

4. The system of claim 1, further comprising:
software which compares trading prices of bonds on said exchange to trading prices of other bonds of similar maturity and assigns a rating in contemplation of relative yields.

5. The system of claim 1, further comprising:
a reporting mechanism which provides real time surety pricing.

6. The system of claim 2, wherein the reporting mechanism provides computer accessible data of surety pricing.

7. The system of claim 1, wherein the surety comprises an internal surety assuring timely payment of the obligations of the trader.

8. The system of claim 1, further comprising:
an auditing mechanism that provides data used in surety pricing.

9. The system of claim 5, wherein the auditing mechanism detects errors, fraud or concentration of risk.

10. The system of claim 5, wherein the auditing mechanism provides real time data.

11. A method for transferring risk to capital markets using the system of 1, comprising:
providing a contract;
enabling the contract exchange system to determine that the contract is eligible;
entering into the contract with the contract exchange system;
transferring risk to a trader; and
transferring risk to an investor in the trader.

12. The method of claim 11, wherein the step of entering into the contract comprises:
unbundling financial rights and obligations of the contract from any services called for by the contract.

13. The method of claim 11, wherein the step of entering into the contract comprises:
unbundling financial rights and obligations of the contract from any surety guarantee.

14. The method of claim 11, wherein the step of entering into the contract comprises:
listing a share of the contract on a liquid contracts exchange.

15. The method of claim 14, further comprising the step of:
trading a share of the contract on a liquid contracts exchange.

16. The method of claim 11, further comprising:
determining that the contract is standardized.

17. The method of claim 16, wherein the step of determining that the contract is standardized comprises:
determining that the contract is part of a set of standardized contracts.

18. The method of claim 11, further comprising:
amending the contract after it has been entered into.

19. The method of claim 11, wherein the step of providing the contract comprises:
creating the contract.

20. The method of claim 11, wherein the step of providing the contract comprises:
modifying an existing contract.

21. The method of claim 11, wherein the step of providing the contract comprises:
renegotiating an existing contract already being traded on an exchange.

22. A method for operating a liquid contracts exchange, comprising:
qualifying traders to become eligible for trading on the exchange;
trading on the contracts exchange using a computer or computer network by the transparent traders;
providing a surety guarantee for each trader's obligations; and
pricing each surety guarantee.

23. The method of claim 22, wherein the step of pricing each surety guarantee comprises:
obtaining relevant data;
tabulating the relevant data using a computer or computer network; and
generating reports of surety pricing.

24. The method of claim 23, wherein the step of obtaining the relevant data comprises:
obtaining information on surety premiums for the traders; and
obtaining information on market values of assets and liabilities held by the traders.

25. The method of claim 24, wherein the step of generating reports of surety pricing comprises:
generating reports containing calculations of surety pricing in relation to each trader's assets and liabilities.

26. The method of claim 22, further comprising:
monitoring a financial condition of each transparent trader.

27. The method of claim 22, further comprising:
restricting substantially all trading on the contracts exchange to transparent traders.

28-109. (canceled)
